(19) United States
(12) Patent Application Publication
(10) Pub. No.: US 2026/0204261 A1
(43) Pub. Date: Jul. 16, 2026

(54) MULTI-DECODER SPEECH RECOGNITION MODELS WITH MULTI-FORMAT OUTPUTS

(71) Applicant: NVIDIA Corporation, Santa Clara, CA (US)

(72) Inventors: Harishchandra Dubey, Snohomish, WA (US); Myungjong Kim, Milpitas, CA (US); Oluwatobi Olabiyi, San Francisco, CA (US); Utkarsh Vaidya, JABALPUR (IN)

(21) Appl. No.: 19/025,548

(22) Filed: Jan. 16, 2025

(51) Int. Cl. G10L 15/26; G10L 25/30

(52) U.S. Cl. CPC G10L 15/26; G10L 25/30

(57) ABSTRACT

Disclosed are apparatuses, systems, and techniques for generating multi-format transcriptions of speech. The techniques include processing, using an encoder, audio frames representative of a speech to generate embeddings encoding the speech and processing, using multiple decoders, the embeddings to generate multiple transcriptions of the speech. An individual transcription is generated by a respective decoder and conforms to a respective text format that differs from other text formats in capitalization, punctuation, use of non-alphabet characters, and/or identification of individual utterances of the speech.

### TECHNICAL FIELD

At least one embodiment pertains to processing resources used to perform and facilitate automatic speech recognition tasks performed with artificial intelligence (AI). For example, at least one embodiment pertains to the use of machine learning techniques for generation of multi-format text outputs from streaming speech inputs.

### BACKGROUND

Speech recognition, also known as automatic speech recognition (ASR) or speech-to-text (STT, S2T), is an intersection of computer technology and linguistics directed to techniques of recognition and translation of spoken language into text. ASR systems often deploy machine-learning models, e.g., trained neural networks, to recognize phonemes, graphemes, words, subwords, sentences, and/or other units of speech. Speaker-independent ASR models rely on general phonetic and semantic characteristics of speech that remain uniform across different speakers. Speaker-dependent ASR models use samples of speech of a particular speaker to fine-tune the models to recognize that person's speech, resulting in increased accuracy of ASR processing.

Other automatic speech tasks facilitated by machine learning include speaker identification that involves associating spoken utterances with speakers whose speech samples are stored a database of speakers (or identifying a new speaker not represented in the database), speaker verification that involves determining whether two or more utterances are spoken by the same speaker or different speakers, speaker diarization that involves partitioning unstructured speech among various participants of a conversation or meeting, and other tasks.

### BRIEF DESCRIPTION OF DRA WINGS

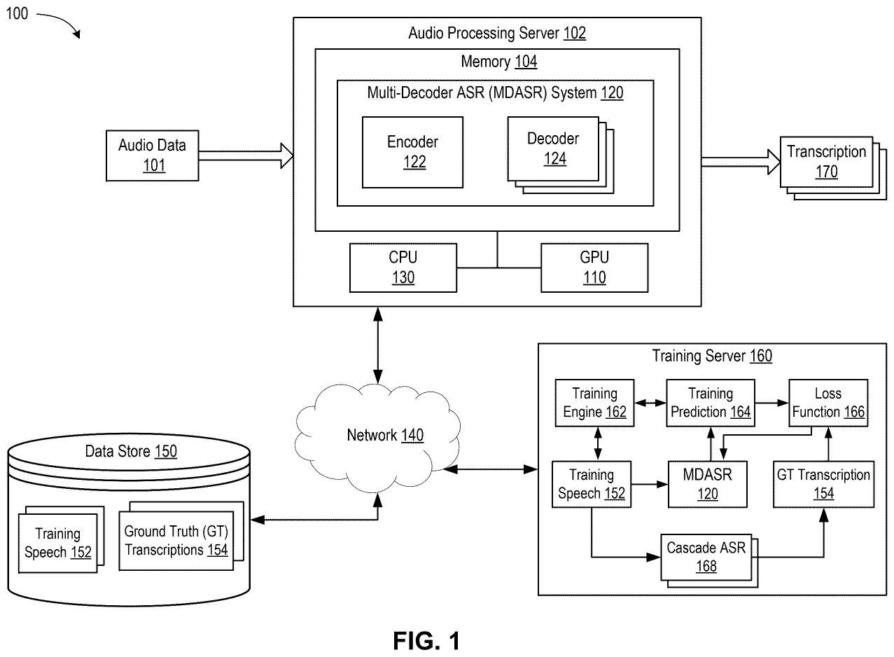

FIG. 1 is a block diagram of an example computer system supporting training and inference operations of a multi-decoder ASR system capable of generating multi-format text outputs, in accordance with at least some embodiments;

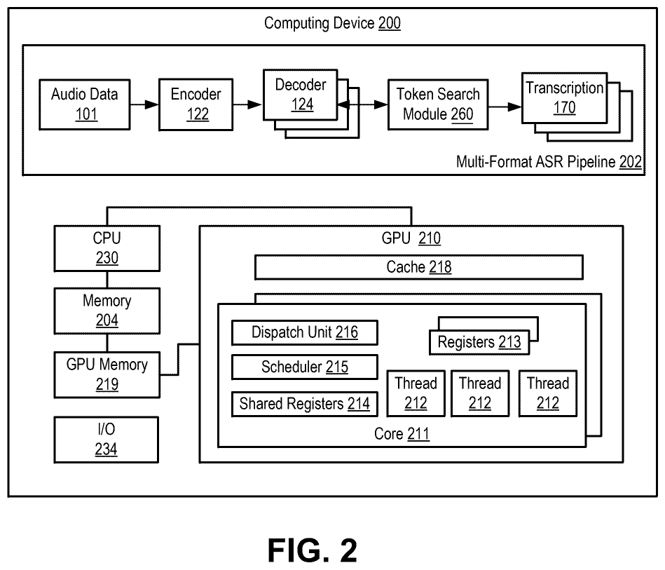

FIG. 2 illustrates an example computing device that deploys and/or trains a multi-decoder ASR system to generate multi-format text outputs, according to at least one embodiment;

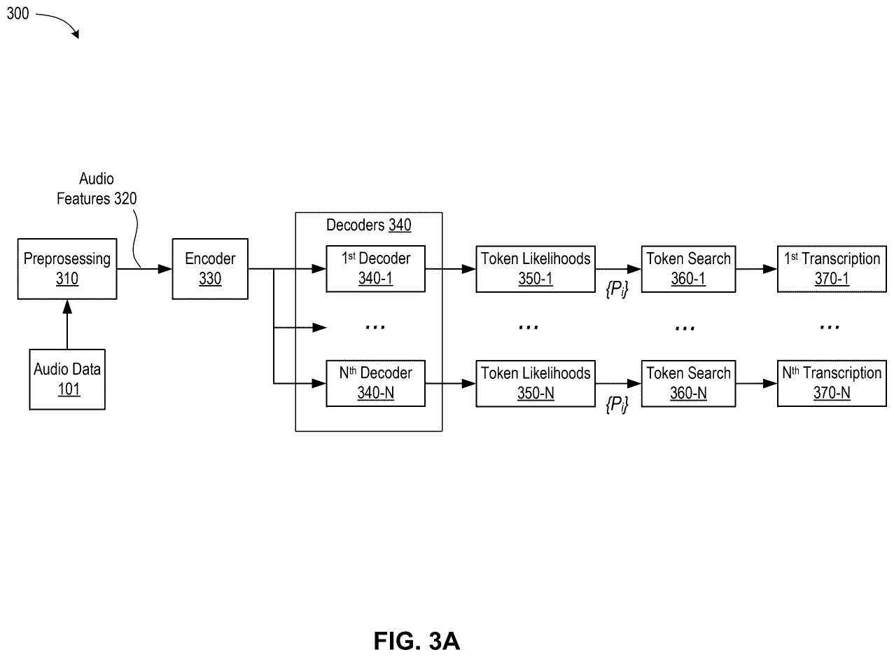

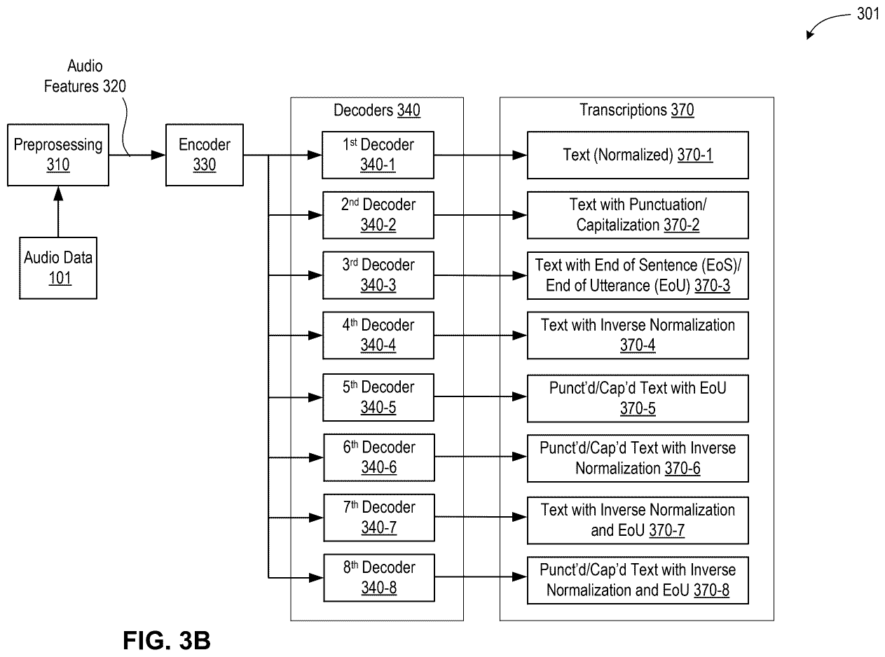

FIG. 3A illustrates an architecture and data flow in an example multi-decoder ASR (MDASR) system that generates speech transcriptions in multiple text formats, according to at least one embodiment;

FIG. 3B illustrates an example eight-decoder MDASR system that generates speech transcriptions in eight individual text formats, according to at least one embodiment;

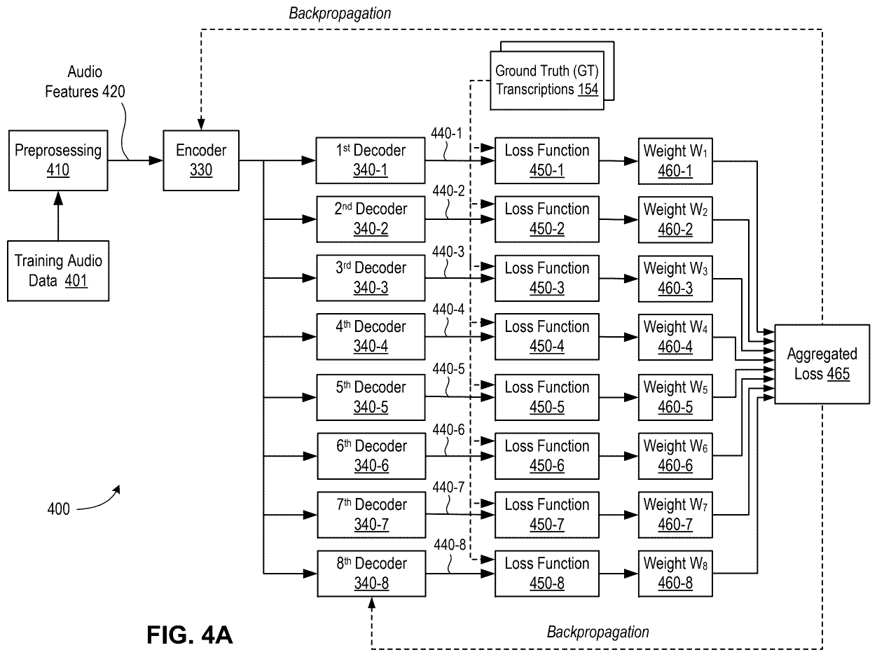

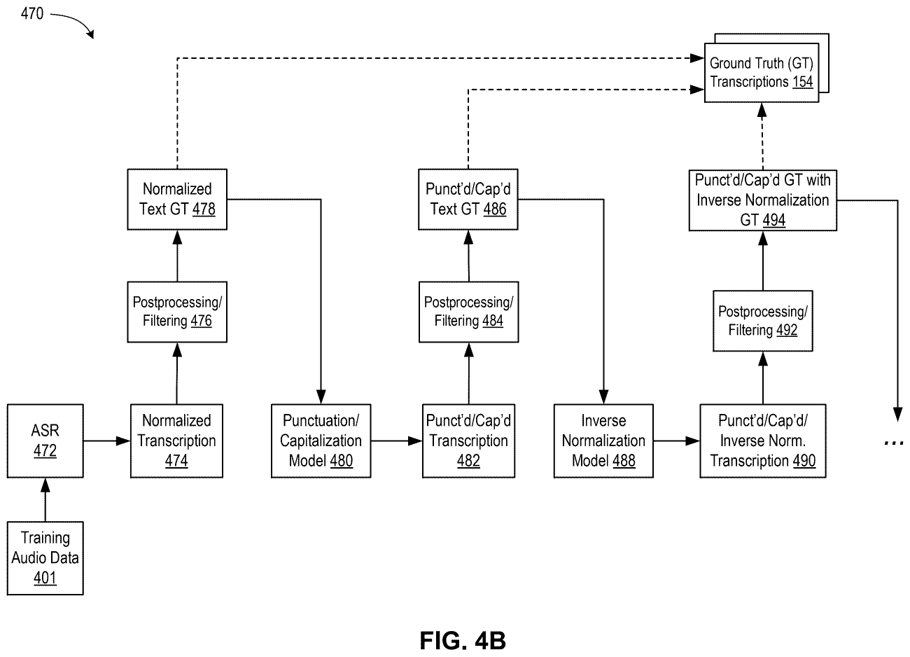

FIG. 4A illustrates example training operations performed in training of an example MDASR system to generate speech transcriptions in multiple text formats, according to at least one embodiment;

FIG. 4B illustrates example generation of training data that may be used in training of MDASR systems that output speech transcriptions in multiple text formats, according to at least one embodiment;

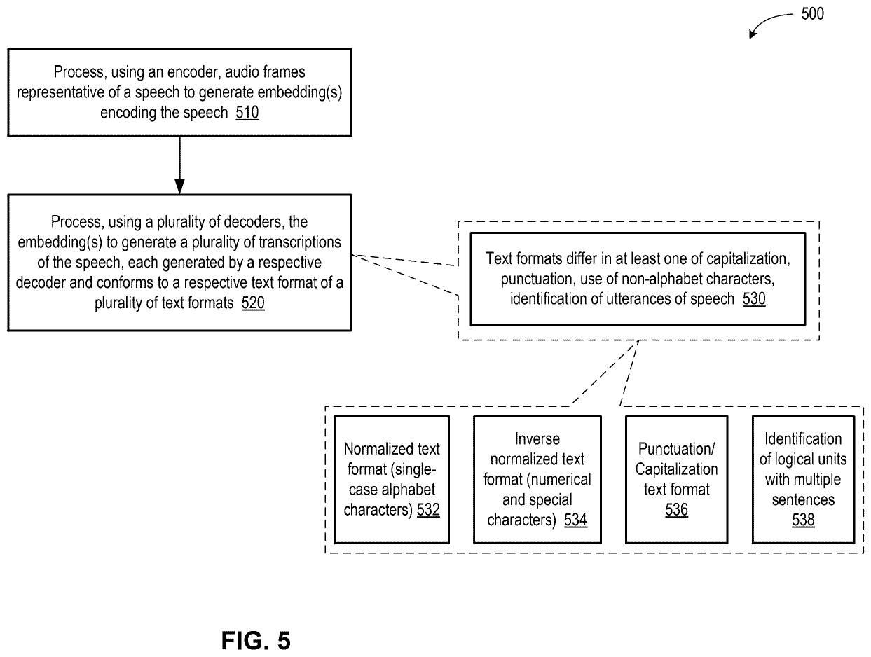

FIG. 5 is a flow diagram of an example method 500 of using an MDASR system to generate multi-format transcriptions of audio inputs, according to at least one embodiment;

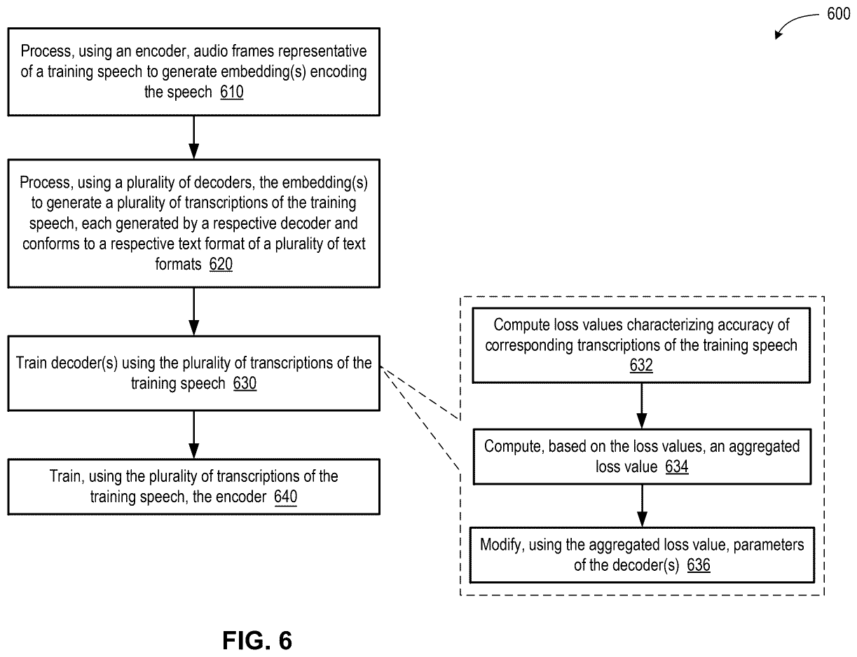

FIG. 6 is a flow diagram of an example method of using an MDASR system to generate multi-format transcriptions of audio inputs, according to at least one embodiment;

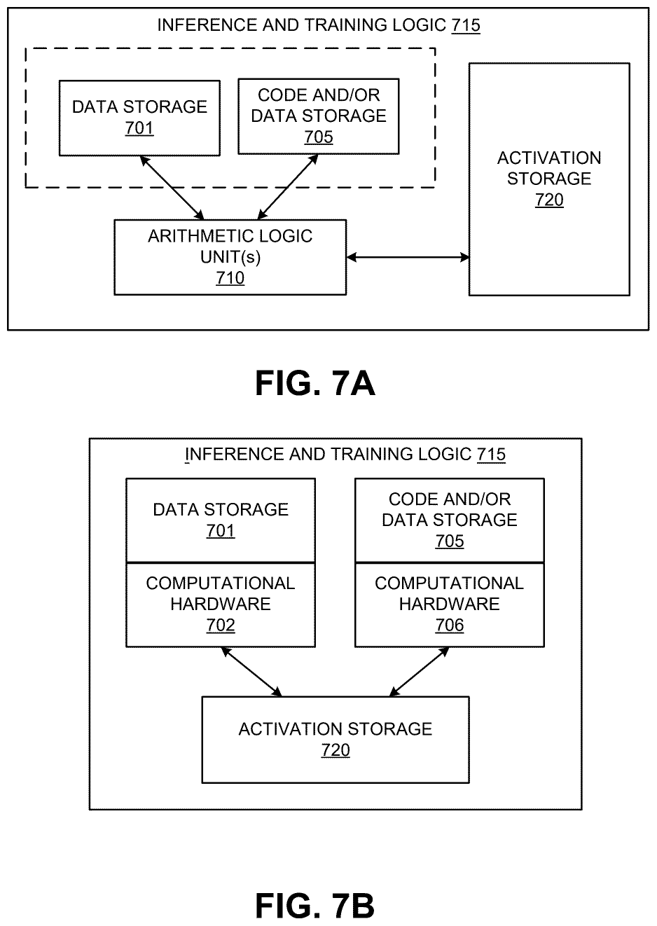

FIG. 7A illustrates inference and/or training logic, according to at least one embodiment;

FIG. 7B illustrates inference and/or training logic, according to at least one embodiment;

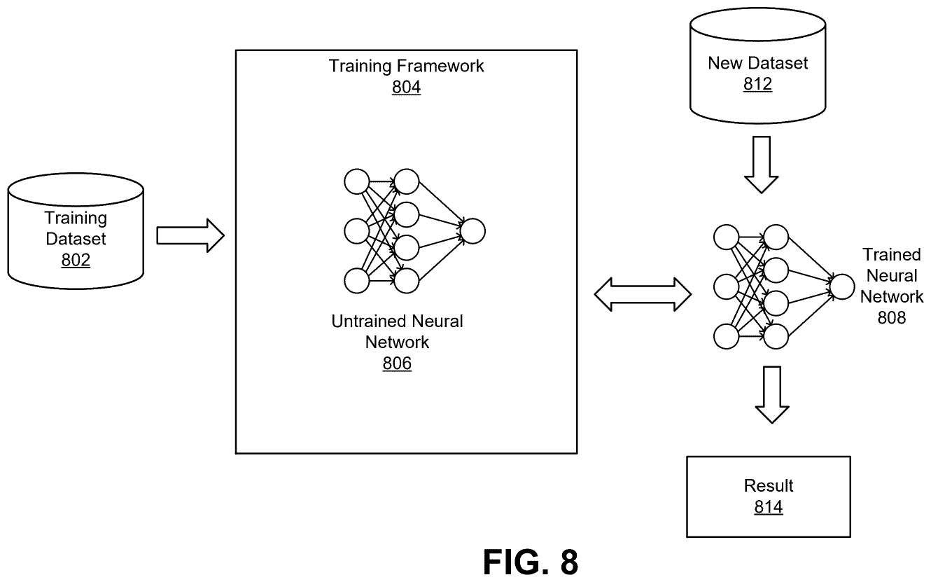

FIG. 8 illustrates training and deployment of a neural network, according to at least one embodiment;

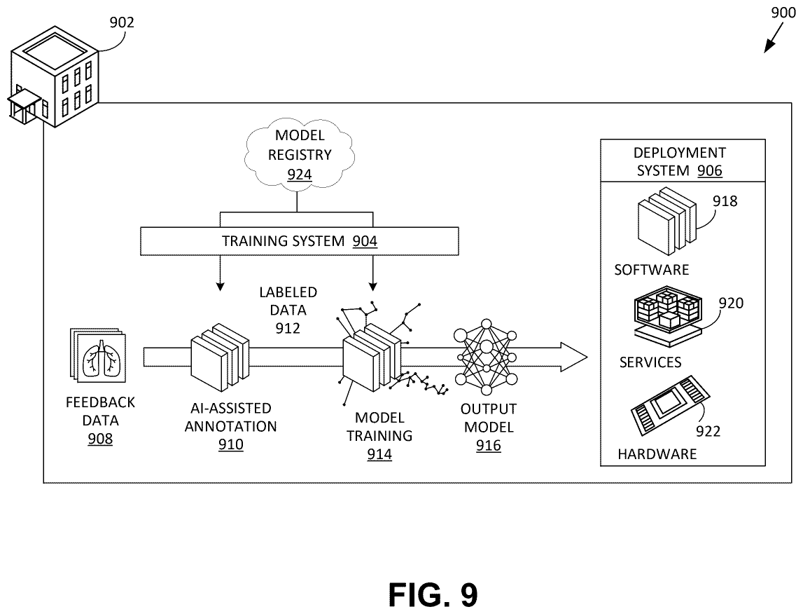

FIG. 9 is an example data flow diagram for an advanced computing pipeline, according to at least one embodiment;

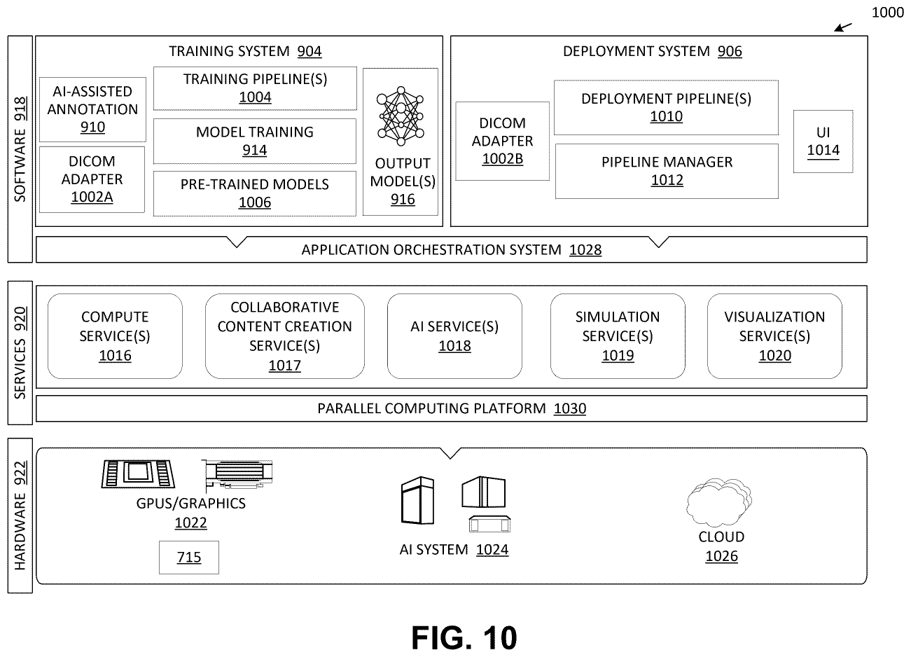

FIG. 10 is a system diagram for an example system for training, adapting, instantiating and deploying machine learning models in an advanced computing pipeline, according to at least one embodiment;

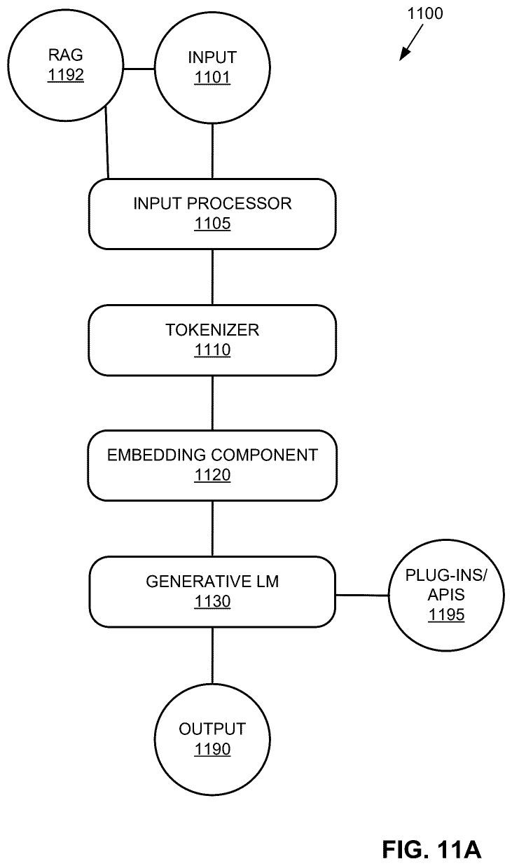

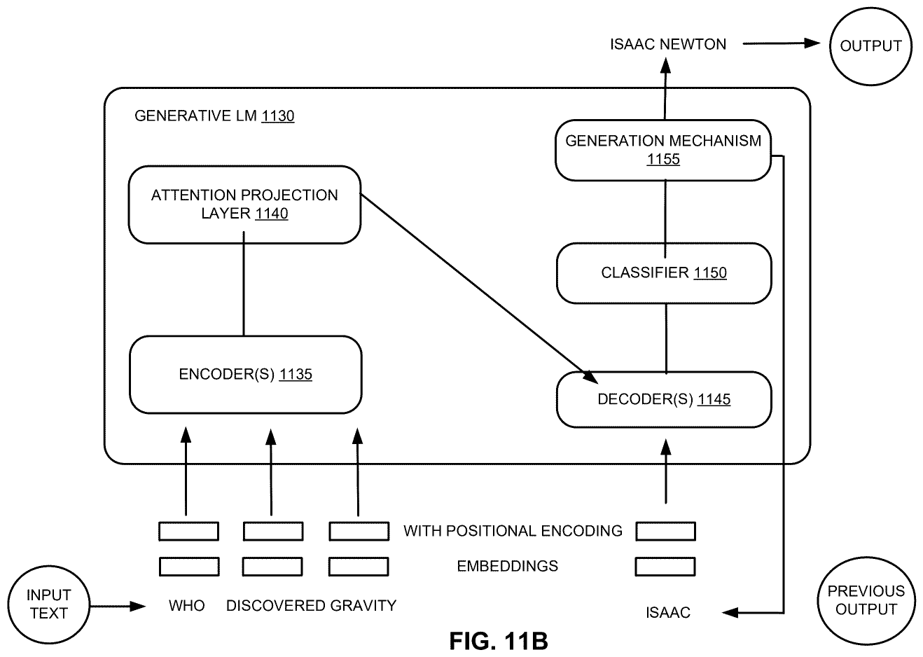

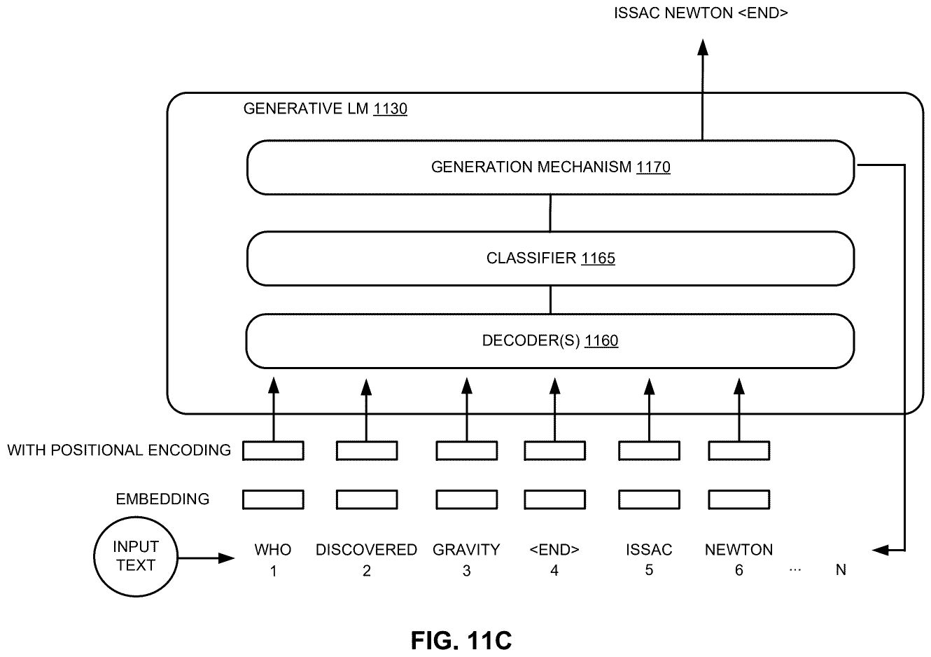

FIG. 11A is a block diagram of an example generative language model system suitable for use in implementing at least some embodiments of the present disclosure;

FIG. 11B is a block diagram of an example generative language model that includes a transformer encoder-decoder suitable for use in implementing at least some embodiments of the present disclosure;

FIG. 11C is a block diagram of an example generative language model that includes a decoder-only transformer architecture suitable for use in implementing at least some embodiments of the present disclosure;

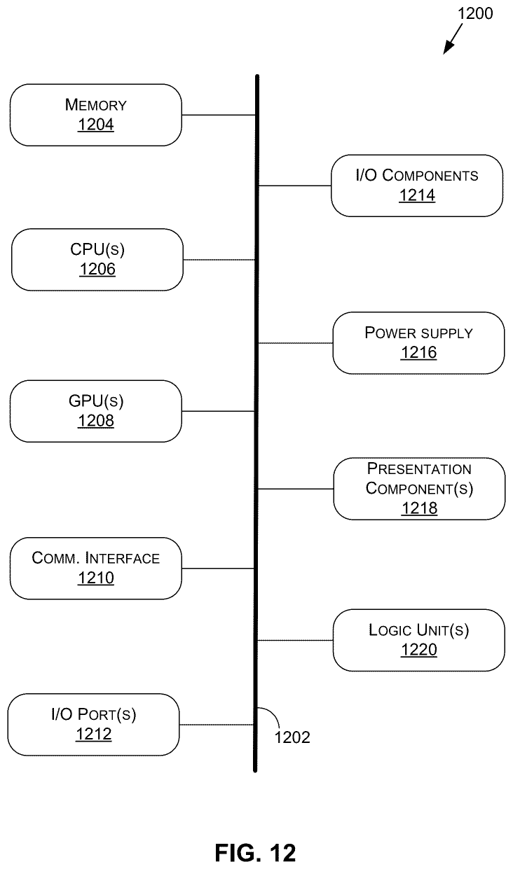

FIG. 12 is a block diagram of an example computing device suitable for use in implementing some embodiments of the present disclosure; and

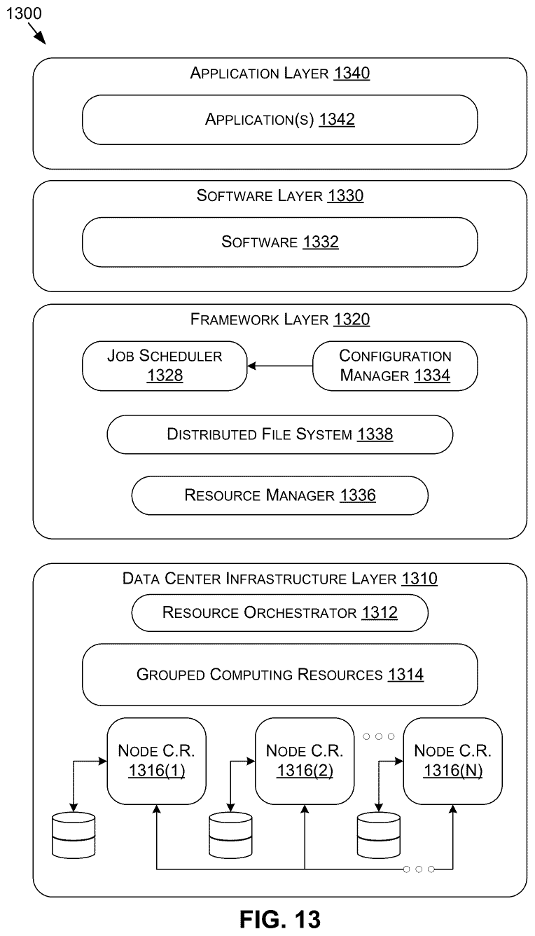

FIG. 13 is a block diagram of an example data center suitable for use in implementing some embodiments of the present disclosure.

### DETAILED DESCRIPTION

ASR systems typically analyze a stream of speech data in the form of (suitably preprocessed) time series of spectrograms or audio frames F₁, F₂, F₃ . . . of a recorded or streamed speech. Model architectures used in ASR systems include connectionist temporal classification (CTC) models, in which text units (characters, words, subwords, etc.) of the transcribed speech are identified (predicted) independently for different frames, transducer models, in which text units are predicted autoregressively, based on both the current frame and the previously predicted units (which provide speech context), and/or models of other types. Different users (customers) can prefer different modes or formats of text outputs. For example, some users may be content with a simple normalized text—the text that is typed in lowercase letters with numerals represented by letters (e.g., with string “two thousand twenty five” used to indicate the year rather than “2025,” as would be customary in standard texts). Such users may use texts for conversion into database entries or as inputs into language models (LMs) or other machine learning models (MLMs) and are, therefore, only interested in words that can be directly converted into tokens (digital representations of words and/or subwords). Other users may also be interested in a correct punctuation and capitalization, e.g., users that generate and distribute readable transcripts of the speech. Some users may be interested in inverse-normalized texts, in which numerals (e.g., “2025”) and common symbols (e.g., %, §, $, @, and so on) are used to replace words, for improved appearance and readability of the texts. Yet other users, e.g., chatbots and various robotic control systems, may be interested in indications of an end of utterance (EoU), which identify larger logical blocks of transcribed speech (e.g., partitioning of a text into paragraphs), and/or indications of an end of sentences (EoS), which identify smaller logical sequences of transcribed words. For example, EoU may capture and mark longer pauses and/or contextual segments of speech inputs while EoS may mark relatively shorter pauses/segments. Knowledge of EoS/EoU locations indicate to a robotic system when a given user command or report may have been communicated to the system so that an action is to be taken or a response to be generated. Some users may also be interested in a suitable combination of multiple modes of text outputs, e.g., a combination of punctuation/capitalization and inverse normalization, or even the ultimate mode with all the above (and/or other) attributes.

The existing ASR systems deploy sequential or cascade processing to generate multi-format text outputs. For example, a first model can perform ASR processing of an input speech to generate a normalized text transcription of the input speech. A second model can then use the output of the first model and add punctuation and capitalization and/or inverse-normalize the output of the first model. In some instances, a cascade of more than two sequential models can incrementally add additional text attributes. Such processing, however, has a number of shortcomings. Errors made by upstream model(s) detrimentally affect accuracy of subsequent model(s) and result in a progressive multiplication of errors in downstream processing. Furthermore, downstream models operate on purely intermediate text outputs and do not take advantage of contextual information contained in the audio inputs. As a result, the valuable audio context is lost in such cascade processing. Furthermore, cascade operations require substantial time for the sequential models to process the input data and, for this reason, are problematic in processing of streaming audio inputs and generating live transcriptions. Finally, retraining cascade models to conform to changing business needs of different customers can be difficult and expensive, e.g., requiring retraining of multiple (or all) models in the cascade using training data of each individual customer (if data is proprietary and/or confidential). Cascade systems also require retraining of each system component for different languages making it more difficult to scale customer-facing products to additional geographic regions and users.

Aspects and embodiments of the present disclosure address these and other technological challenges of the modern ASR technology by providing for multi-decoder ASR systems capable of generating multi-format text outputs independently, e.g., in parallel. In one example, a multi-decoder ASR system may include a common encoder network (or, simply, encoder herein) that is in series with a decoder block having multiple decoder networks (or, simply, decoders herein), whose number need not be limited and may be equal to the number of different modes or formats of text outputs (and/or combinations of such modes). Individual decoders may receive the same audio embeddings (feature vectors) generated by the encoder and may be trained to generate text outputs of one of the formats. For example, the first decoder may generate normalized text, the second decoder may generate text with punctuation and capitalization, the third decoder may generate text with inverse normalization, the fourth decoder may generate text with end-of-utterance (and/or beginning-of-utterance) indications, the fifth decoder may generate text with both punctuation/capitalization and inverse normalization, and so on. An encoder processes audio frames of the input speech while the decoders (which may include CTC decoders, transducer decoders, and/or other suitable decoder) generate probabilities that various units of text are present in the transcribed speech. Such units, also referred to as transcription tokens or simply tokens herein, can correspond to individual characters, letters, numerals, groups of words (subwords), whole words, combinations of multiple words, punctuation marks, EoU indicators, and/or the like. The generated probabilities may be used to select the most likely next token in the speech transcription that is being generated. For example, in a greedy decoding, a token having the highest probability may be selected as the next token. In a beam search decoding, multiple hypotheses may first be formed that include a certain number of consecutive tokens with a tree of hypotheses maintained and used at individual steps of the decoding process.

Training of the multi-decoder ASR may be performed in a single stage, including training of the encoder and multiple decoders. The audio frames may be passed through an encoder and then through the individual decoders (e.g., in parallel). A suitable loss function may be computed for individual decoder paths. Individual loss functions from multiple decoders may then be combined (e.g., summed) into an aggregated loss, which is then used for backpropagation-based model training (fine-tuning, updating, etc.). For example, the loss function(s) may be applied to the decoder outputs (predictions) in view of correct (ground truth) predictions and generate loss values characterizing performance of individual decoders. In some embodiments, the individual loss values may be aggregated, e.g., using a set of weights assigned to various decoders, and the aggregated loss may be used to train the entire system, e.g., using various techniques of backpropagation. In some embodiments, the multi-decoder ASR may be trained end-to-end with the encoder trained together with the decoders. In other embodiments of the disclosed system the encoder can be initially trained with one (or a first group of several) decoders. Once such initial training converges to an acceptable accuracy, another decoder (or a group of decoders) may be added and the training may continue for the whole system. Similarly, more decoders may be added at subsequent training stages. As accuracy of some of the decoders reaches a target accuracy (e.g., decoders associated with simper text formats, such as normalized text formats), parameters (e.g., weights and biases) of the corresponding decoders may be fixed (frozen) while parameters of decoders generating less accurate outputs may undergo additional training, e.g., using the aggregated loss from both frozen and still learning decoders.

In some embodiments, a multi-decoder ASR system with both the encoder and the decoders pre-trained using some public training data may then be offered to users (customers) for further training using users' proprietary and/or confidential data. For example, a user may be interested in training and deploying a certain number (though not all) of the available decoders, e.g., the normalized text decoder, the punctuated/capitalized text decoder, and the text decoder that outputs punctuated/capitalized text with both EoU and inverse normalization. The user may enable and train the decoders of the selected modes/formats (while not deploying the other available decoders) using the user's training data. In those instances where the user may acquire additional training data (e.g., associated with a new knowledge or marketing/application domain), the user may retrain (fine-tune, update) the deployed decoders (and, optionally, the encoder). In those instances, where the user becomes interested in a new format, the corresponding decoder may simply be initiated and trained without having to retrain previously deployed decoders.

In some embodiments, the multi-decoder ASR system may specialize in a particular language. In other embodiments, the multi-decoder ASR system may be multi-lingual. In such instances, training data may include input speech in multiple languages (e.g., English, Spanish, German, etc.) together with corresponding ground truth for the input speech that includes normalized texts, texts with punctuation, capitalization, EoUs, inversely normalized texts, and/or any combinations thereof. During training, the multi-decoder ASR system learns, from the training data, how to identify the correct language and output transcriptions in the correct language according to the modes/formats of the respective decoders.

In some embodiments, the training data may be generated by trained cascade systems in which different components may be trained separately. Next, outputs of such systems may be taken as ground truth for training the student multi-decoder ASR system(s). To minimize errors in the synthetic training data obtained using the cascade systems, the training data may be suitably filtered or improved to remove outliers. For example, transcriptions generated by the cascade system(s) may first be evaluated using an evaluator (discriminator model) that ranks quality of the outputs according to a suitable ranking scheme, e.g., 0, 1, 2, . . . N, which may include the word error rate (WER) for normalized text predictions, WER for punctuated/capitalized text predictions, and so on. The outputs that have a ranking below a certain minimum threshold ranking N_{MIN} may be discarded while higher-quality outputs may be used as ground truth to train multi-decoder ASR systems. In some embodiments, outputs of different cascade systems may be used for cross-verification of training data. For example, transcriptions (or suitable metrics representative of the transcriptions, such as WER) output by a first cascade system configured to generate texts with punctuations and capitalization may be compared with WERs of transcriptions output by a second cascade system configured to generate texts with inverse normalization in the following way: the outputs may be compared in the aspects that are common to both cascade systems, e.g., in transcriptions reduced to lowercase letters (with punctuation and difference between upper-case and lower-case letters disregarded). Provided that two (or more) transcriptions are substantially similar, e.g., with the rate of mismatched words or letters below a certain target rate, the corresponding transcriptions may be deemed to be of sufficient quality and included in the training data. If such transcriptions differ by more than the acceptable target rate of error, both transcriptions may be deemed unreliable and excluded from the training data. In some embodiments, multiple state-of-the-art ASR models (e.g., which use the same tokenizers) may be used to process the same audio data and generate transcriptions. The transcriptions that have high correlations (above an empirically set threshold) across such multiple ASR models may be included in the training data (together with the underlying audio inputs) and transcriptions that have low correlations (below the set threshold) may be excluded from the training data.

In some embodiments, speech in the training data may be generated by one or more state-of-the-art text-to-speech (T2S) models producing synthetic speech for various input texts, with the known texts then used as ground truth transcriptions for the speech outputs of T2S models (which are used as speech inputs in training of multi-decoder ASR systems).

The advantages of the disclosed techniques include but are not limited to elimination of error accumulation when more advanced text formatting rules are applied to less advanced text formats. Instead, when decoders generating less advanced outputs achieve respective format proficiency and are frozen, accurate outputs from such decoders guide other decoders that are still learning in achieving a similar proficiency in more advanced formatting tasks. Since the inputs into the decoders represent audio embeddings, the audio context of uttered speech is efficiently used in training of all decoders. Furthermore, the parallel architecture of the encoder-multi-decoder systems significantly reduces processing times and make the trained system capable of streaming speech inputs. Additionally, the disclosed architecture provides flexibility of efficient and inexpensive retraining and updating the multi-mode ASR systems when new user data becomes available or when a user wishes to expand speech-to-text processing to include additional formats, languages, and/or use cases.

### System Architecture

FIG. 1 is a block diagram of an example computer system 100 supporting training and inference operations of a multi-decoder ASR system capable of generating multi-format text outputs, in accordance with at least some embodiments. As depicted in FIG. 1, a computer system 100 may include an audio processing server 102, a data store 150, and a training server 160 connected to a network 140. Network 140 may be a public network (e.g., the Internet), a private network (e.g., a local area network (LAN), or wide area network (WAN)), a wireless network, a personal area network (PAN), a combination thereof, and/or another network type.

Audio processing server 102 may include a desktop computer, a laptop computer, a smartphone, a tablet computer, a server, a wearable device, a VR/AR/MR headset or head-up display, a digital avatar or chatbot kiosk, a live translation service, an in-vehicle infotainment computing device, and/or any suitable computing device capable of performing the techniques described herein. Audio processing server 102 may be configured to receive audio data 101 that may be associated with any speech episode involving one or more speakers. Speech episodes may include a public or private conversation, a business meeting, a public or private presentation, an artistic event, a political rally, a religious sermon, a debate, an interaction between a digital agent (e.g., chatbot, digital avatar, digital assistant, etc.) and one or more users, an in-vehicle communication (e.g., between two or more occupants, between an occupant(s) and a chat bot, avatar, or digital assistant of the vehicle), and/or the like. Audio data 101 may be recorded using one or more devices connected to audio processing server 102, retrieved from memory 104 of audio processing server 102, and/or received over any local (e.g., bus, interconnect, cable, etc.) or network connection (e.g., via network 140) from an external computing device. Audio data 101 may be in any suitable format, e.g., WAV, AIFF, MP3, AAC, WMA, or some other compressed or uncompressed audio format. In some embodiments, audio data 101 may be stored (e.g., together with other data, such as metadata) in data store 150. Additionally, data store 150 may store training audio data, including training speech 152 and/or target (ground truth) transcriptions 154 of training speech 152 for training one or more models capable of transcribing speech in multiple modes (formats), according to one or more embodiments disclosed herein. Data store 150 may be accessed by audio processing server 102 directly or (as shown in FIG. 1) via network 140.

Data store 150 may include a persistent storage capable of storing audio files as well as metadata for the stored audio files. Data store 150 may be hosted by one or more storage devices, such as main memory, magnetic or optical storage disks, tapes, or hard drives, network-attached storage (NAS), storage area network (SAN), and so forth. Although depicted as separate from audio processing server 102, in at least some embodiments, data store 150 may be a part of audio processing server 102. In at least some embodiments, data store 150 may be a network-attached file server, while in other embodiments, data store 150 may be some other type of persistent storage such as an object-oriented database, a relational database, and so forth, that may be hosted by a server machine or one or more different machines coupled to the audio processing server 102 via network 140.

Audio processing server 102 may include a memory 104 (e.g., one or more memory devices or units) communicatively coupled with one or more processing devices, such as one or more graphics processing units (GPU) 110, one or more central processing units (CPU) 130, one or more data processing units (DPU), one or more network interface cards (NICs)—such as one or more superNICs, one or more parallel processing units (PPUs), and/or other processing devices (e.g., field-programmable gate arrays (FPGAs), application-specific integrated circuits (ASICs), and/or the like). Memory 104 may store one or more components and models, such as a multi-decoder ASR (MDASR) system 120 that may include one or multiple models trained and configured to recognize spoken words in audio data 101. In some embodiments, MDASR system 120 may include an encoder 122 trained to process audio data 101 and convert various units of audio data 101 (which may be represented via audio spectrograms or frames) into digital embeddings (or audio features) having a smaller number of values that nonetheless capture important characteristics of the speech sufficient to ensure accurate transcription of spoken utterances in audio data 101. MDASR system 120 may may further include multiple decoders 124 trained to use the embeddings generated by encoder 122 as inputs and to output tokens of the transcribed speech, e.g., in the form of probabilities (or log-probabilities) of various vocabulary tokens (e.g., defined at training) to occur at various positions of the transcription. The number of trained decoders 124 may be two, three, four, five, eight, or any other number of modes/formats defined at training. The outputs of decoders 124 (e.g., probabilities of various predicted tokens) may be used to obtain multiple transcriptions 170 conforming to respective text formats.

Any of the encoder 122 and/or decoders 124 of MDASR system 120 may be implemented as deep learning neural networks having multiple levels of linear and/or non-linear operations. For example, each or some of the deployed neural networks may include convolutional neural networks, recurrent neural networks, fully-connected neural networks, recurrent neural networks (RNNs) long short-term memory (LSTM) neural networks, neural networks with attention, e.g., transformer neural networks, conformer neural networks (combinations of transformer blocks with convolutional blocks), and/or the like. In one example, encoder 122 may be a transformer network and decoders 124 may be conformer networks. In another example, encoder 122 may be a conformer network and decoders 124 may be transformer networks. In some embodiments, both encoder 122 and decoders 124 may be of the same or similar type, e.g., both conformers or both transformers. In at least one embodiment, any, some, or all deployed neural networks may include multiple neurons, with an individual neuron receiving its input from other neurons and/or from an external source and producing an output by applying an activation function to the sum of (trainable) weighted inputs and, in some neurons, a bias value. In at least one embodiment, one or more of the deployed neural networks may include multiple neurons arranged in layers, including an input layer, one or more hidden layers, and/or an output layer. Neurons from adjacent layers may be connected by weighted edges. In some embodiments, training server 160 may train a number of different MDASR system 120, which may be models that differ by a number of neurons, number of neuron layers, activation functions, specific neural architecture, and/or the like.

Training server 160 may use training speech 152 and target transcriptions 154 to train MDASR system 120 or any portion thereof, including encoder 122 and decoders 124, to identify parameters (e.g., neural weights, biases, parameters of activation functions, etc.) of the networks in a way that maximizes success of speech recognition by MDASR system 120. Training server 160 may be (or include) a desktop computer, a laptop computer, a smartphone, a tablet computer, a server, and/or any suitable computing device capable of performing the techniques described herein. In at least one embodiment, training server 160 and audio processing server 102 may be implemented on a single computing device. Training server 160 may host training engine 162 that orchestrates and performs various tasks, jobs, and operations of the training process.

In some embodiments, during training, training engine 162 may cause MDASR system 120 to process training speech 152 in one or more target languages, and output a training prediction 164, which may include multiple training transcriptions of training speech 152 in any defined number N of text formats, e.g., a normalized text format (lowercase letters with no numerals and/or special characters), a punctuated/capitalized text format, an inverse-normalized text format, a text format with EoU indications, and/or any other text format or a combination of two or more text formats. The generated training prediction 164 may be compared, using one or more loss functions 166 to ground truth transcriptions 154 in the respective text formats. Training engine 162 may compare the differences between the training prediction 164 and ground truth transcriptions 154 and may backpropagate the value of the computed loss function(s) 166 through networks of MDASR system 120 changing various network parameters (e.g., weights and biases of individual neurons) to bring training prediction(s) 164 closer to ground truth transcriptions 154. In some embodiments, a cascade ASR system 168 may be deployed as a teacher model that uses a combination (e.g., sequence) of two or more models to process training speech 152 and generate ground truth transcriptions 154, e.g., by incrementally adding more advanced text features, e.g., by adding punctuation/capitalization and/or EoU indications to normalized text, converting letters and words into numerals and various special characters and/or the like. In some embodiments, ground truth transcriptions 154 generated by the cascade ASR system 168 may be additionally screened, filtered, and/or improved to remove instances of training speech 152 for which ground truth transcriptions 154 have low confidence or have been determined to be of low quality.

Initially, edge parameters (e.g., weights and biases) of MDASR system 120 may be assigned some starting (e.g., random) values. Various error or mismatches between training predictions 164 and ground truth transcriptions 154, e.g., as may be quantified by loss function(s) 166, may be back-propagated through MDASR system 120 and at least some parameters of the system may be changed in a way that brings training predictions 164 closer to ground truth transcriptions 154. Such adjustments may be repeated until the output error for a given training input 152 satisfies a predetermined condition (e.g., falls below a predetermined error). Subsequently, a different training input 152 may be selected, a new training prediction 164 generated, and a new series of adjustments implemented, until the model is trained to a target degree of accuracy or until the model reaches the limit of its (architecture-determined) accuracy. One or more trained MDASR system 120 may then be used, during the inference stage, for processing of new (not encountered previously) speech utterances.

Training speech 152 may be stored in a data store 150 in a raw audio format, e.g., in the form of spectrograms, or in any other suitable representation characterizing speech. For example, a spectrogram of training speech 152 may be obtained by recording air pressure caused by the speech as a function of time and computing a short-time Fourier transform for overlapping time intervals (frames) of a set duration. This maps the audio signal from the time domain to the frequency domain and generates a spectrogram characterizing the spectral content of training speech 152. The amplitude of the audio signal may be represented on a logarithmic (decibel) scale. In some embodiments, the obtained spectrograms may be further converted into mel-spectrograms, by transforming frequency f into a non-linear mel domain, f→m=a ln(1+f/b), to take into account the ability of a human ear to better distinguish between equally spaced frequencies (tones) at the lower end of the frequencies of the audible spectrum than at its higher end. In one example, a=1607 and b=700 Hz. Throughout this disclosure, the term “speech spectrogram” may be understood to include Fourier spectrograms or mel-spectrograms, where applicable.

FIG. 2 illustrates an example computing device 200 that deploys and/or trains a multi-decoder ASR system to generate multi-format text outputs, according to at least one embodiment. In at least one embodiment, computing device 200 may be a part of audio processing server 102. In at least one embodiment, computing device 200 may be a part of training server 160. In at least one embodiment, computing device 200 supports a multi-format ASR pipeline 202 that includes (but need not be limited to) encoder 122, decoders 124, token search module 260, and/or other modules or components that may be used by the pipeline. Multi-format ASR pipeline 202 may be capable of processing audio data 101 and generating accurate multiple transcriptions 170 corresponding to multiple modes/text formats for audio data 101. Operations of the multi-format ASR pipeline 202 may be executed using one or more GPUs 210, one or more CPUs 230, one or more parallel processing units (PPUs) or accelerators, such as a deep learning accelerator, data processing units (DPUs), and/or the like. In at least one embodiment, a GPU 210 includes multiple cores 211. An individual core 211 may be capable of executing multiple threads 212. An individual core 211 may run multiple threads 212 concurrently (e.g., in parallel). In at least one embodiment, any, some, or all threads 212 may have access to registers 213. Any, some, or all registers 213 may be thread-specific registers with access to a register restricted to a respective thread. Additionally, any, some, or all shared registers 214 may be accessed by one or more (e.g., all) threads of the core. In at least one embodiment, individual cores 211 may include a scheduler 215 to distribute computational tasks and processes among different threads 212 of core 211. A dispatch unit 216 may implement scheduled tasks on appropriate threads using correct private registers 213 and shared registers 214. Computing device 200 may include input/output component(s) 234 to facilitate exchange of information with one or more users or developers.

In at least one embodiment, GPU 210 may have a (high-speed) cache 218, access to which may be shared by any, some, or all cores 211. Furthermore, computing device 200 may include a GPU memory 219 where GPU 210 may store intermediate and/or final results (outputs) of various computations performed by GPU 210. After completion of a particular task, GPU 210 (or CPU 230) may move the output to (main) memory 204. In at least one embodiment, CPU 230 may execute processes that involve serial computational tasks whereas GPU 210 may execute tasks (such as multiplication of inputs of a neural node by weights and adding biases) that are amenable to parallel processing. In at least one embodiment, the multi-format ASR pipeline 202 may determine which processes are to be executed on GPU 210 and which processes are to be executed on CPU 230. In other embodiments, CPU 230 may determine which processes are to be executed on GPU 210 and which processes are to be executed on CPU 230.

In some examples, the machine learning models (e.g., MDASR system 120 or parts thereof, e.g., encoder 122, decoders 124, etc.) described herein may be packaged as a microservice—such an inference microservice (e.g., NVIDIA NIMs)—which may include a container (e.g., an operating system (OS)-level virtualization package) that may include an application programming interface (API) layer, a server layer, a runtime layer, and/or a model “engine.” For example, the inference microservice may include the container itself and the model(s) (e.g., weights and biases). In some instances, such as where the machine learning model is small enough (e.g., has a small enough number of parameters), the model(s) may be included within the container itself. In other examples—such as where the model(s) is large—the model(s) may be hosted/stored in the cloud (e.g., in a data center) and/or may be hosted on-premises and/or at the edge (e.g., on a local server or computing device, but outside of the container). In such embodiments, the model(s) may be accessible via one or more APIs—such as REST APIs. As such, and in some embodiments, the machine learning models described herein may be deployed as an inference microservice to accelerate deployment of models on any cloud, data center, or edge computing system, while ensuring the data is secure. For example, the inference microservice may include one or more APIs, a pre-configured container for simplified deployment, an optimized inference engine (e.g., built using a standardized AI model deployment an execution software, such as NVIDIA's Triton Inference Server, and/or one or more APIs for high performance deep learning inference, which may include an inference runtime and model optimizations that deliver low latency and high throughput for production applications—such as NVIDIA's TensorRT), and/or enterprise management data for telemetry (e.g., including identity, metrics, health checks, and/or monitoring). The machine learning model(s) described herein may be included as part of the microservice along with an accelerated infrastructure with the ability to deploy with a single command and/or orchestrate and auto-scale with a container orchestration system on accelerated infrastructure (e.g., on a single device up to data center scale). As such, the inference microservice may include the machine learning model(s) (e.g., that has been optimized for high performance inference), an inference runtime software to execute the machine learning model(s) and provide outputs/responses to inputs (e.g., user queries, prompts, etc.), and enterprise management software to provide health checks, identity, and/or other monitoring. In some embodiments, the inference microservice may include software to perform in-place replacement and/or updating to the machine learning model(s). When replacing or updating, the software that performs the replacement/updating may maintain user configurations of the inference runtime software and enterprise management software.

### Multi-Decoder Automatic Speech Recognition Systems

FIG. 3A illustrates an architecture and data flow in an example multi-decoder ASR (MDASR) system 300 that generates speech transcriptions in multiple text formats, according to at least one embodiment. In at least one embodiment, the system illustrated in FIG. 3A may be the MDASR system 120 of FIG. 1, which may be implemented as part of audio processing server 102 located on a single computing device or distributed across multiple computing devices. Various blocks in FIG. 3A denoted with the same numerals as the respective blocks of FIG. 1 and/or FIG. 2 may implement the same (or a similar) functionality.

MDASR system 120 may receive audio data 101 captured by one or more audio sensors, e.g., microphones. Microphones can include dynamic microphones, condenser microphones, ribbon microphones, unidirectional microphones, omnidirectional microphones, and/or any other types of microphones. In some embodiments, a microphone can be combined with other devices, e.g., computers, phones, speakers, TV screens, and/or the like. The audio data 101 collected by the audio sensors may be generated, e.g., spoken, by any number of speakers and may include a single speech episode or multiple speech episodes. The audio sensors may capture not only a speech signal but also background noise, interference signals, e.g., emitted by TV devices, radio devices, alarm devices, and/or any other equipment, or sounds naturally occurring (e.g., sound of wind, water, birds, etc.). In some embodiments, audio data 101 may be retrieved from memory (e.g., memory 104 of audio processing server 102 in FIG. 1), and/or received over any local or network connection (e.g., via network 140 in FIG. 1) from an external computing device or memory.

Audio data 101 may undergo a suitable preprocessing 310. For example, preprocessing 310 may include audio filtering, denoising, amplification, dereverberation, segmentation, and/or any other audio enhancement. Preprocessing 310 may further include removal of portions of the audio data 101 that do not have a speech content. For example, preprocessing 310 may evaluate energy e(t) associated with the audio data as a function of time and identify regions that have energy less than a certain threshold (e.g., an empirically determined noise threshold). Such identified regions may be removed (trimmed) from the audio data 101 during speech preprocessing 310. Segmentation may include apportioning the audio data 101 into intervals of a predetermined sizes (durations), t, e.g., 0.1-5 sec. Such intervals are sometimes referred to as units herein. It should be understood that a unit need not correspond to a complete logical portion of speech and may encompass one or more sentences, one or more words, a part of a word, one or more phonemes, a portion of a phoneme, one or more exclamations, filler words, pauses, and/or the like. In some embodiments, the units (intervals) may be partially overlapping.

Individual units may be represented by one or more of frames, e.g., T frames over time τ or any other predetermined interval. Frames may have a duration of 15 msec, 20 msec, 30 msec, and/or some other duration. Frames may undergo a suitable frame-to-spectrogram transformation. For example, a spectrogram of a frame may be obtained or generated by performing a discrete Fourier transform of acoustic energy e(t) or air pressure p(t) associated with a specific utterance. The obtained spectrograms e(fⱼ) may be defined for a number of bands f₁, f₂ . . . f_{C}, for example, for C=80 bands or C=128 bands, or any other number of bands. In some embodiments, the bands may be mel-bands and the spectrograms may be mel-spectrograms. Separate spectrograms may be obtained for separate audio frames.

The preprocessed audio data 101 may be converted into audio features 320, also referred to as embeddings, e.g., using wav2vec converter or any other suitable audio-to-embedding converter. An embedding (audio feature) should be understood as any suitable digital representation of audio data 101, e.g., as a vector (string) of any number D of components, which can have integer values or floating-point values. Embeddings can be considered as vectors or points in a D-dimensional embedding space. The dimensionality D of the embedding space can be smaller than the size of the audio data 101 (or corresponding spectrograms or frames representing audio data 101). An embeddings model generating audio features 320 may be trained to associate similar sets of training audio spectrograms/frames with similar embeddings represented by points closely situated in the embedding space and further trained to associate dissimilar sets of training audio spectrograms/frames represented by points that are located farther apart in the embedding space. In some embodiments, a separate embedding (or a separate set of embeddings) can represent a given audio spectrogram/frame or a set of a predetermined number of audio spectrograms/frames.

A given audio feature 320 can encode one or more words or a subword (e.g., one or more syllables of a word). For the sake of simplicity and convenience of illustration but not limitation, it may be presumed below that an individual audio feature encodes acoustic and lexical information of a portion of audio data 101 that corresponds to one subword.

Audio features 320 may be processed by an encoder 330 that generates recomputed audio features capturing both the local (short-range) speech context (as represented by audio features 320 associated with close frames) and the global (long-range) speech context (as represented by more distant audio features 320). The recomputed audio features may be processed by a block of decoders 340, which may include any number of individual decoders 340-1 . . . 340-N whose outputs may be used to generate corresponding transcriptions 370-1 . . . 370-N. Each transcription 370-k may be associated with a text format that differs from other text formats by the presence or absence of one or more formatting or stylistic features, e.g., capitalization, punctuation, use of non-alphabet characters (numerals, special characters, etc.), end-of-utterance indications, end-of-sentence indications (e.g., when performed for transcriptions that lack punctuations) and/or the like.

In some embodiments, individual decoders 340-1 . . . 340-N may process the recomputed audio features to generate respective token likelihoods 350-1 . . . 350-N, e.g., probabilities {Pᵢ} (or corresponding log-probabilities Lᵢ=log Pᵢ) that various vocabulary tokens τᵢ are present in speech units X₁, X₂ . . . , each speech unit represented by one or more audio frames F₁, F₂, F₃ . . . . F_{M} of that unit, e.g., as may be set by durations of individual frames and units. For example, if an individual frame Fⱼ has a duration of 60 msec and an individual speech unit Xₖ includes four frames, the duration of the unit may be 240 msec. In some embodiments, any, some, or all decoders 340-k may be CTC decoders that generate sets of probabilities {Pₖ} independently for different speech units Xₖ. In some embodiments, any, some, or all decoders 340-k may be transducer decoders that maintain a state Sₖ of the speech capturing a context of tokens predicted for at least some previous speech units X₁ . . . . Xₖ₋₁ and processes the state Sₖ together with the audio features for the current speech unit Xₖ (as generated by encoder 330) to produce a set of probabilities {Pₖ} for the current speech unit. (In the standard transducer terminology, the decoder updates the state of the speech while an additional network, often referred to as a joiner network, processes the updated state of the speech together with the encoded features to generate the token probabilities. For brevity and conciseness, the term “decoder,” as used herein, should be understood as including both the decoder and the joiner networks of transducer models, where applicable.) In some embodiments, decoder 340-k may be an RNN-Transducer or some other token-and-duration (TDT) decoder that predicts, together with probabilities {Pₖ}, durations of various tokens.

Separate sets of token likelihoods 350-k may be predicted, by respective decoders 340-k for individual tokens τᵢ of respective token vocabularies. Token vocabularies used by different decoders 340-k may be different. For example, a token vocabulary of a decoder that generates normalized text transcriptions may include lowercase letters while a token vocabulary of a decoder that generates punctuated/capitalized transcriptions may also include punctuation marks (e.g., period, comma, colon, semicolon, exclamation mark, question mark, dashes, etc.) and uppercase letters, a token vocabulary of a decoder that generates inverse-normalized text may include numerals and special characters (e.g., %, $, €, §, etc.), a token vocabulary of a decoder that generates end-of-utterance/beginning-of-utterance indicators may include suitable tokens of such indicators. Similarly, token vocabularies of a decoder that generates a combination of multiple formats may include a union of the corresponding vocabularies. For example, a decoder that generates inverse-normalized text with capitalization/punctuation may include lowercase letters, uppercase letters, numerals, and special characters. In some embodiments, even a token vocabulary of normalized text transcriptions may be a union of multiple sets of tokens. For example, a token vocabulary of the Chinese language may be a union of traditional Chinese characters and simplified Chinese characters.

A number of output channels of a given decoder 340-k may be equal to the number of tokens in the decoder's token vocabulary with individual probabilities Pᵢ output by respective channels (e.g., for each speech unit Xₖ) and indicating likelihoods that respective tokens τᵢ of the decoder's token vocabulary are spoken or implied from cadence and/or voice modulation (e.g., a question mark token, an exclamation mark token, an end-of-utterance token, etc.) during a given speech unit Xₖ.

Token searches 360-1 . . . 360-N may use the respective sets of token likelihoods 360-1 . . . 360-N to select the most likely final tokens for the current speech unit Xₖ to be added to the speech transcriptions 370-1 . . . 370-N and may include greedy searches, depth-first searches, breadth-first searches, beam searches, and/or some combination thereof. In a greedy decoding, a token having the highest probability Pᵢ may be selected as the final token for speech unit Xₖ. In other searching algorithms, e.g., in a beam search decoding, multiple token hypotheses may first be formed for a certain number (e.g., a sliding window) of consecutive speech units Xₖ and a tree of hypotheses may be maintained. A token hypothesis that maximizes the likelihood that several consecutive tokens are present in the transcription (e.g., as may be represented by a product of the corresponding probabilities or, equivalently, by a sum of log-probabilities) may be selected as the final token for speech unit Xₖ (followed by moving the sliding window to the next speech unit Xₖ₊₁). In some embodiments, more than one token may be determined at once (e.g., for a group of consecutive speech units).

FIG. 3B illustrates an example eight-decoder MDASR system 301 that generates speech transcriptions in eight individual text formats, according to at least one embodiment. Operations of MDASR system 301 may be similar to operations illustrated in FIG. 3A, with blocks indicated with same numerals, e.g., preprocessing 310, encoder 330, decoders 340, etc. performing the same or similar operations. Some operations illustrated in conjunction with FIG. 3A, e.g., token searches 360-1 . . . 360-N performed using token likelihoods 350-1 . . . 350-N, which may also be used by the MDASR system 301, are not shown explicitly in FIG. 3B for conciseness and ease of viewing. As illustrated, the MDASR system 301 may deploy the following decoders 340.

A first decoder 340-1 may be used to generate a normalized text transcription 370-1, e.g., a text with no punctuation or capitalization with units of text represented via lowercase letters. For example, audio data 101 may include “We will rent you a GPU. It will be one hundred dollars.” The first decoder 340-1 may be trained to generate the normalized text transcription 370-1 that includes <<we will rent you a gpu it will be one hundred dollars >>.

A second decoder 340-2 may be used to generate a text transcription with punctuation and capitalization 370-2, e.g., a text with punctuation marks and capital letters used in appropriate places. For the same example audio data 101, the second decoder 340-2 may be trained to generate the transcription 370-2 that includes <<We will rent you a GPU. It will be one hundred dollars.>>

A third decoder 340-3 may be used to generate a text transcription with end-of-sentence (EoS) and/or end-of-utterance (EoU) indications 370-3. For the same example audio data 101, the third decoder 340-3 may be trained to generate the transcription 370-3 that includes <<we will rent you a gpu <EoS> it will be one hundred dollars <EoS> <EoU>>>.

A fourth decoder 340-4 may be used to generate a text transcription with inverse normalization 370-4. For the same example audio data 101, the fourth decoder 340-4 may be trained to generate the transcription 370-4 that includes <<we will rent you a gpu it will be $100>>.

A fifth decoder 340-5 may be used to generate a text transcription with punctuation/capitalization and EoS/EoU indications 370-5. For the same example audio data 101, the fifth decoder 340-5 may be trained to generate the transcription 370-5 that includes <<We will rent you a GPU. It will be one hundred dollars. <EoU>>>

A sixth decoder 340-6 may be used to generate a text transcription with punctuation/capitalization and inverse normalization 370-6. For the same example audio data 101, the sixth decoder 340-6 may be trained to generate the transcription 370-6 that includes <<We will rent you a GPU. It will be $100. >>

A seventh decoder 340-7 may be used to generate a text transcription with inverse normalization and EoS/EoU 370-7. For the same example audio data 101, the seventh decoder 340-7 may be trained to generate the transcription 370-7 that includes <<we will rent you a gpu <EoS> it will be $100<EoS> <EoU>>>.

An eighth decoder 340-8 may be used to generate a text transcription with punctuation/capitalization, inverse normalization, and EoU 370-8. For the same example audio data 101, the eighth decoder 340-8 may be trained to generate the transcription 370-8 that includes <<We will rent you a GPU. It will be $100. <EoU>>>

The transcriptions illustrated in conjunction with FIG. 3B should be understood in a way of illustration and not limitation. Numerous other text formats and combinations of text formats may be defined (as part of training of individual decoders 340-k) and the number of defined formats supported by deployed decoders need not be limited.

The disclosed systems and techniques may be used in a streaming (live, online, etc.) mode, e.g., for transcribing a live speech (conversations, monologues, presentations, etc.), and in an offline mode, e.g., for transcribing a pre-recorded speech. In the instances of streaming mode transcriptions, the length (duration) of audio data 101 may be 0.5-2 sec whereas in the instances of offline mode transcriptions, the length (duration) of audio data 101 may be longer, e.g., 10-30 sec, in one non-limiting illustrative example.

FIG. 4A illustrates example training operations 400 performed in training of an example MDASR system to generate speech transcriptions in multiple text formats, according to at least one embodiment. In at least one embodiment, operations 400 or similar operations may be used to train MDASR system 120 of FIG. 1, MDASR system 300 of FIG. 3A, MDASR system 301 of FIG. 3B, and/or other similar systems.

Operations 400 may include receiving training audio data 101, e.g., audio recording of training speech 152 (with reference to FIG. 1), which may be fetched from a data store 150 or recorded by live audio sensors. Training audio data 101 may undergo preprocessing 410, which may be the same or similar to preprocessing 310 performed as part of inference operations described in conjunction with FIG. 3A. In some embodiments, (training) preprocessing 410 may include additional operations not performed as part of (inference) preprocessing 310 of FIG. 3A, e.g., discarding audio recordings of poor quality, selecting audio segments of specific durations, performing additional quality enhancement, and/or the like. Preprocessing 410 may include representing training audio data via audio features 420. Audio features 420 may be processed by encoder 330 that recomputes the audio features before providing the recomputed audio features for further processing to decoders 340-1 . . . 340-8 whose outputs may be used to generate corresponding training transcriptions (training predictions) 440-1 . . . 440-8. Each training transcription 440-k may be generated by the decoder 340-k that is being trained to generate transcriptions of one of the target formats, e.g., as illustrated in conjunction with FIG. 3B or other text formats. Decoders 340-k may be CTC decoders, transducer decoders, time-and-duration (e.g., RNN-transducer) decoders, and/or the like. Although not shown explicitly for conciseness and ease of viewing, generating training transcriptions may also include operations not shown in FIG. 4A, including but not limited to performing token searches, e.g., a greedy search, a depth-first search, a breadth-first search, a beam search, and/or the like, as described in conjunction with FIG. 3B.

Each training transcription 440-k may be evaluated, by a respective loss function 450-k in relation to ground truth transcriptions 154 for the respective text format. For example, a ground truth transcription for the speech utterance “We will rent you a GPU. It will be one hundred dollars” and the normalized text format may be “we will rent you a gpu it will be one hundred dollars” whereas a ground truth transcription for the same speech utterance and the text format that includes punctuation, capitalization, and inverse normalization may be “We will rent you a GPU. It will be $100.”

In some embodiments, various loss functions 450-1 . . . 450-8 may be the same loss function, e.g., the binary cross-entropy loss function, the Kullback-Leibler loss function, and/or another suitable loss function. In some embodiments, some of loss functions 450-k may be different from other loss functions. Loss function 450-k may quantify the difference between a distribution of likelihoods {Pᵢ} for a given transcription unit X predicted using an output of the respective decoder 340-k and the ground truth transcription unit X_{GT}. In particular, the higher the likelihood predicted for the correct transcription token for the unit X, the lower the value of the loss function may be. Loss values computed for individual transcription units of training speech (or a certain portion of training speech) may be combined, such as added (e.g., in the instances of log-probabilities being used for the likelihoods) or multiplied (e.g., in the instances of probabilities being used for the likelihoods), with the resulting loss value Lₖ quantifying an error of the corresponding decoder 340-k predictions.

In some embodiments, individual loss values Lₖ may then be aggregated, e.g., using a set of weights 460-1 . . . 460-8, to compute aggregated loss 465:

$${L}_{A G G} = {\sum }_{k = 1}^{N} {W}_{k} \times {L}_{k} .$$

The set of weights {Wₖ} may be assigned empirically, e.g., based on field testing. In some embodiments, all weights may be the same, at least initially. In some embodiments, the weights may be normalized,

$${\sum }_{k = 1}^{N} {W}_{k} = 1 .$$

As tanning progresses, weights may also change, e.g., more (or less) weights may be given to errors associated with decoders 340-k whose accuracy is less than accuracy of other decoders. The aggregated loss 465 may be used to train individual decoders 340-k, e.g., using various techniques of backpropagation to change parameters (e.g., weights and biases) of the decoders, as illustrated schematically with the dashed arrows in FIG. 4A.

In some embodiments, the MDASR system may be trained end-to-end with encoder 330 trained together with decoders 340-1 . . . 340-N. In other embodiments, encoder 330 may be trained first followed by training of decoders 340-1 . . . 340-N. In some embodiments, encoder 330 may be trained in conjunction with one, two or some other low number of transcription formats before most of decoders 340-1 . . . 340-N are trained. For example, initially decoder 330 may be pretrained together with decoder 340-1 that is to generate normalized text transcriptions. After pretraining of encoder 330, parameters of encoder 330 may be fixed (frozen) while training of the decoders may continue (as in the case of decoder 340-1) or commence (as in the case of decoders 340-2 . . . 340-N). In some embodiments, training of encoder 330 and/or at least some of the decoders, e.g., decoder 340-1, may be performed using public data followed by freezing of encoder 330 and continuing further training of the decoders 340-k using private and/or proprietary data (e.g., in situation where the amount of private/proprietary data in insufficient for training both encoder 330 and decoders 340-k). As accuracy of predictions of individual decoders reaches a target accuracy (e.g., decoders associated with simper text formats), parameters of the corresponding decoders may be frozen while parameters of decoders generating less accurate outputs may undergo further training. In some embodiments, such further training may use the aggregated loss 465 computed both from frozen and still learning decoders. In other embodiments, further training may use the aggregated loss from still learning decoders but not from frozen decoders.

During training, learning rate may be set according to a schedule that may be determined based on the accuracy of outputs of different decoders 340-k. Initially, learning rate may be set at a higher value and, as outputs of various decoders 340 become more accurate (e.g., as indicated by the decreasing values of the corresponding loss functions 450-k), learning rates for those decoders may be lowered. In some embodiments, learning rates for any, some, or all decoders 340-k may be set to the same value (which may vary synchronously as the training progresses). In some embodiments, learning rates may be set individually for different decoders 340-k, in view of the current accuracy of their outputs.

FIG. 4B illustrates example generation 470 of training data that may be used in training of MDASR systems that output speech transcriptions in multiple text formats, according to at least one embodiment. As illustrated in FIG. 4B, the training data may be generated using trained ASR and text processing models arranged in a cascade system that is used to generate ground truth (GT) for training MDASR system(s). As illustrated, a training audio data 401 may be used as an input into an ASR model 472 trained to generate a text transcription in a suitable format, which may be a normalized transcription 474, in one example. Normalized transcription 474 may use lowercase alphabet characters and a space to indicate breaks between words. Training audio data 401 may be public training data or private training data, e.g., proprietary data and/or confidential data used by a particular user and/or organization of the user to train an MDASR system for private use by the user/organization. In some embodiments, training audio data may include data from the University of Pennsylvania. Linguistic Data Consortium (LDC), or similar data.

In some embodiments, normalized transcription 474 may be used as normalized text ground truth 478 by training engine 162 to train one of the decoders of the MDASR system, e.g., decoder 340-1 that generates normalized text transcription 370-1 (with reference to FIG. 3B). In some embodiments, normalized transcription 474 generated by ASR model 472 may first undergo postprocessing/filtering 476 or other quality improvement to minimize transcription errors. For example, a human developer may review and correct errors in normalized transcription 474. In some embodiments, such reviews/corrections may be performed on a subset of training audio data, e.g., in those instances where the training audio data has a large volume. In some embodiments, normalized transcription 474 may be evaluated using an evaluator model, which may be a trained discriminator model that ranks quality of normalized transcription 474 according to a suitable ranking scheme, e.g., 0, 1, 2, . . . . N. In some embodiments, postprocessing/filtering 476 may screen normalized transcription 474 for hallucinations. For example, a voice activity detection (VAD) model may process training audio data 401 and determine a duration of the voice portion of training data 401 (as distinguished from noise, and/or silence). Postprocessing/filtering 476 may then compare the determined duration to the number of transcribed words, subwords, and/or characters in normalized transcription 474 and may flag and eliminate outputs that have a significant mismatch, e.g., transcriptions having too many or too few words in comparison with the determined duration of the voice, and/or the like. In some embodiments, operations of postprocessing/filtering 476 may be contingent upon a mean opinion (MOS) score for the training audio data 401, e.g., measured on the 1 (bad) to 5 (excellent) scale, with training audio data 401 having the MOS score of 5 or 4 (good) exempt from the postprocessing. The MOS scores may likewise be determined by the VAD model or using some other trained discriminator model.

Normalized transcriptions 474 and corresponding training audio data 401 having a ranking below a certain minimum (e.g., empirically set) threshold ranking N_{MIN} may be discarded while higher-quality outputs may be used as normalized text ground truth 478 to train multi-decoder ASR systems. In some embodiments, a certain bottom percentile (e.g., bottom 30%) of all encountered normalized transcriptions 474 and corresponding training audio data 401 may be discarded.

Normalized text ground truth 478 may then be used as an input into another (downstream) model of the cascade system, e.g., a punctuation/capitalization model 480 trained to add punctuation and capitalization to the normalized input. The output, punctuated/capitalized transcription 482 may be used as punctuated/capitalized ground truth 486 by a training engine (e.g., training engine 162 in FIG. 1) to train one of the decoders of the MDASR system, e.g., decoder 340-2 that generates text transcriptions with punctuation and capitalization 370-2 (with reference to FIG. 3B). In some embodiments, punctuated/capitalized transcription 482 may undergo postprocessing/filtering 484 that may be performed similarly to postprocessing/filtering 476 of normalized transcription 474 using a human developer input, an evaluator model process, and/or other techniques disclosed above or additional techniques.

Punctuated/capitalized ground truth 486 may then be used as an input into the next model of the cascade system, e.g., an inverse normalization model 488 trained to represent some of the words of the inputs with numerals and common special characters. The output, punctuated/capitalized transcription with inverse normalization 490 may then be used as punctuated/capitalized ground truth with inverse normalization 494 by the training engine to train one of the decoders of the MDASR system, e.g., decoder 340-6 that generates text transcriptions with punctuation/capitalization and inverse normalization 370-6 (with reference to FIG. 3B). In some embodiments, punctuated/capitalized transcription 482 may also undergo postprocessing/filtering 492 that may be performed similarly to postprocessing/filtering 476 or 484 using a human developer input, an evaluator model process, and/or other techniques.

Additional (not shown in FIG. 4B for conciseness) models may be included in the cascade system, e.g., a model that adds EoU to input transcriptions. Although one example cascade system is illustrated in FIG. 4B, other cascade systems are within the scope of the instant disclosure, e.g., systems that differ by the number of models, specific sequences of models, and/or the like. In some embodiments, a cascade system may have a tree-like or a graph-like structure with various leaves of the tree of nodes or the graph generating ground truth for training of one of the decoders.

In some embodiments, a user/organization may be interested in training and deploying a certain number (though not all) of the available decoders, e.g., the normalized text decoder, the punctuated/capitalized text decoder, and the text decoder that outputs punctuated/capitalized text with both EoU and inverse normalization. The user may select (e.g., from a menu provided on a user interface, including a graphical user interface) and train the decoders of the selected modes/formats (while not initially deploying other available decoders) using the user's training data. In those instances where the user may acquire additional training data (e.g., associated with a new knowledge or marketing domain), the user may retrain (fine-tune, update) the deployed decoders (and, optionally, the encoder). In those instances, where the user becomes interested in a new format, the corresponding decoder may be initiated and trained without having to retrain previously deployed decoders.

In some embodiments, the multi-decoder ASR system may be trained in a particular language. In other embodiments, the multi-decoder ASR system may undergo multi-lingual training. In such instances, training data may include input speech in multiple languages (e.g., English, Spanish, German, etc.) together with corresponding ground truth for the input speech that includes normalized texts, texts with punctuation, capitalization, EoUs, inversely normalized texts, and/or any combinations thereof. Multi-lingual MDASR systems may be trained to predict tokens of multiple language, e.g., an MDASR system trained to output transcriptions in both English and German may predict a probability of occurrence of tokens of a vocabulary that is the union of tokens of both the English language and the German language. During training, the multi-decoder ASR system learns, from the training data, how to identify the correct language and output transcriptions in the correct language according to the formats of the respective decoders.

FIG. 5 and FIG. 6 illustrate example methods of training MDASR systems and using MDASR systems to generate multi-format transcriptions of audio inputs, according to at least one embodiment. Methods 500 and 600 illustrated in FIG. 5 and FIG. 6 may be performed using one or more processing units (e.g., CPUs, GPUs, accelerators, PPUs, DPUs, etc.) of by audio processing server 102 of FIG. 1. The one or more processing units may include (or communicate with) one or more memory devices. In at least one embodiment, processing units performing method 500 and/or method 600 may be executing instructions stored on a non-transitory computer-readable storage media. In at least one embodiment, method 500 and/or method 600 may be performed using multiple processing threads (e.g., CPU threads and/or GPU threads), individual threads executing one or more individual functions, routines, subroutines, or operations of the methods. In at least one embodiment, processing threads implementing method 500 and/or method 600 may be synchronized (e.g., using semaphores, critical sections, and/or other thread synchronization mechanisms). Alternatively, processing threads implementing method 500 and/or method 600 may be executed asynchronously with respect to each other. Various operations of method 500 and/or method 600 may be performed in a different order compared with the order shown in FIG. 5 and/or FIG. 6. Some operations of method 500 and/or method 600 may be performed concurrently with other operations. In at least one embodiment, one or more operations shown in FIG. 5 and/or FIG. 6 may not always be performed.

Method 500 and/or 600 may involve transcriptions of speech utterances produced by humans or computers (including robots, chatbots, game characters, etc.) in any possible context, e.g., a conversation, a public speech, a public event, a business meeting, a conference, a street encounter, an interaction in a game, an interaction with a chatbot or digital avatar, an interaction with an in-vehicle infotainment system, and/or the like.

FIG. 5 is a flow diagram of an example method 500 of using an MDASR system to generate multiple-format transcriptions of audio inputs, according to at least one embodiment. At block 510, method 500 may include processing, using an encoder (e.g., encoder 330 in FIG. 3A or FIG. 3B), one or more audio frames (e.g., frames of audio data 101) representative of a speech to generate one or more embeddings encoding the speech.

At block 520, method 500 may continue with processing, using a plurality of decoders (e.g., decoders 340 in FIG. 3A or FIG. 3B), the one or more embeddings to generate a plurality of transcriptions of the speech (e.g., transcriptions 370-1 . . . 370-N in FIG. 3A or FIG. 3B). An individual transcription of the plurality of transcriptions may be generated using a respective decoder of the plurality of decoders and may conform to a respective text format of a plurality of text formats. As illustrated with block 530, various text formats may differ from other text formats of the plurality of text formats in at least one of capitalization, punctuation, use of non-alphabet characters, or identification of individual utterances of the speech.

In some embodiments, the plurality of text formats may include (as illustrated with block 532) a normalized text format associated with representing text content with single-case (e.g., lowercase) alphabet characters. In some embodiments, the plurality of text formats may include (as illustrated with block 534) an inverse normalized text format associated with representing numbers with numeral characters (e.g., 0, 1, 2, etc.). In some embodiments, the inverse normalized text format may be further associated with representing at least some of vocabulary words with non-alphanumerical characters. In some embodiments, the plurality of text formats may include (as illustrated with block 536) a text format that includes punctuation and/or capitalization. In some embodiments, the plurality of text formats that include identification of individual utterances of the speech may include (as illustrated with block 538) identification of at least one content unit of the speech, the content unit including multiple sentences of the speech having a common meaning, common logic, common semantics, common context, and/or the like. In some embodiments, the plurality of text formats may include one or more text formats that include a combination of at least two other text formats of the plurality of text formats.

In some embodiments, the plurality of decoders comprises one or more connectionist temporal classification (CTC) decoders, one or more transducer decoders, one or more hybrid CTC-transducer decoders, one or more token-and-duration transducer decoders, and/or the like. In some embodiments, the plurality of decoders may be trained using an aggregated loss value computed based on at least a plurality of loss values, an individual loss value of the plurality of loss values being associated with an accuracy of a training text output generated, by a corresponding decoder of the plurality of decoders, for a training speech input. In some embodiments, training of one or more components of the MDASR system may be performed as illustrated in conjunction with FIG. 6.

FIG. 6 is a flow diagram of an example method 600 of using an MDASR system to generate multi-format transcriptions of audio inputs, according to at least one embodiment. At block 610, one or more processing units executing method 600 may process, using an encoder (e.g., encoder 330 in FIG. 4A or FIG. 4B), one or more audio frames (e.g., frames of training audio data 401) representative of a training speech to generate one or more embeddings encoding the training speech.

At block 620, method 600 may include processing, using a plurality of decoders (e.g., decoders 340 in FIG. 4A or FIG. 4B), the one or more embeddings to generate a plurality of transcriptions of the training speech. An individual transcription of the plurality of transcriptions may be generated by a respective decoder of the plurality of decoders and may conform to a respective text format of a plurality of text formats. Various text formats may differ from other text formats of the plurality of text formats in at least one of capitalization, punctuation, use of non-alphabet characters, or identification of individual utterances of the training speech. For example, the audio frame(s) may be represented by respective audio feature(s) (e.g., audio features 320, with reference to FIG. 3 and FIG. 4). The audio features may be digital embeddings obtained by converting (embedding) a suitable representation of a speech recording to an embedding space. In one example, the audio features are obtained using one or more audio spectrograms of a portion of an audio recording capturing the one or more spoken words.

At block 630, method 600 may include training one or more decoders of the plurality of decoders based on at least the plurality of transcriptions of the training speech. In some embodiments, method 600 may include, at block 640, training the encoder using the plurality of transcriptions of the training speech. In some embodiments, training operations of blocks 630 and/or 640 may include one or more operations illustrated with the callout portion of FIG. 6. More specifically, at block 632, method 600 may include computing a plurality of loss values (e.g., using loss functions 450-1 . . . 450-N, as illustrated in FIG. 4A). An individual loss value of the plurality of loss values may characterize accuracy of a corresponding transcription (e.g., training transcriptions 440-1 . . . 440-N) of the plurality of transcriptions of the training speech. At block 634, method 600 may include computing, based on at least the plurality of loss values, an aggregated loss value (e.g., aggregated loss 465 in FIG. 4A). In some embodiments, at least two loss values of the plurality of loss values may be weighted with unequal weights (e.g., weights 460-1 . . . 460-N in FIG. 4A) in the aggregated loss value. At block 636, method 600 may continue with modifying, using the aggregated loss value, parameters of the one or more decoders (e.g., using techniques of backpropagation, gradient descend, and/or the like).

In some embodiments, the plurality of loss values may be computed based on a plurality of ground truth transcriptions (e.g., ground truth transcriptions 154 in FIG. 4A or FIG. 4B). The ground truth transcriptions may be generated by processing the training speech using a cascade automatic speech recognition (ASR) system. The cascade ASR system may include an ASR model (e.g., ASR model 472 in FIG. 4B) configured to process training speech to generate a first ground truth transcription (e.g., normalized text ground truth 478 in FIG. 4B) of the plurality of ground truth transcriptions. The ASR system may further include one or more text processing models (e.g., punctuation/capitalization model 480, inverse normalization model 488, in FIG. 4B, and/or the like) configured to process the first ground truth transcription to generate a second ground truth transcription (e.g., punctuated/capitalized text ground truth 486, punctuated/capitalized text ground truth with inverse normalization 494, and/or the like) of the plurality of ground truth transcriptions.

The systems and methods described herein may be used for a variety of purposes, by way of example and without limitation, for machine (e.g., robot, vehicle, construction machinery, warehouse vehicles/machines, autonomous, semi-autonomous, and/or other machine types) control, machine locomotion, machine driving, synthetic data generation, model training (e.g., using real, augmented, and/or synthetic data, such as synthetic data generated using a simulation platform or system, synthetic data generation techniques such as but not limited to those described herein, etc.), perception, augmented reality (AR), virtual reality (VR), mixed reality (MR), robotics, security and surveillance (e.g., in a smart cities embodiment), autonomous or semi-autonomous machine applications, deep learning, environment simulation, object or actor simulation and/or digital twinning, data center processing, conversational AI, light transport simulation (e.g., ray-tracing, path tracing, etc.), distributed or collaborative content creation for 3D assets (e.g., using universal scene descriptor (USD) data, such as OpenUSD, and/or other data types), cloud computing, generative artificial intelligence (e.g., using one or more diffusion models, transformer models, etc.), and/or any other suitable applications.

Disclosed embodiments may be comprised in a variety of different systems such as automotive systems (e.g., a control system for an autonomous or semi-autonomous machine, a perception system for an autonomous or semi-autonomous machine), systems implemented using a robot or robotic platform, aerial systems, medial systems, boating systems, smart area monitoring systems, systems for performing deep learning operations, systems for performing simulation operations (e.g., in a driving or vehicle simulation, in a robotics simulation, in a smart cities or surveillance simulation, etc.), systems for performing digital twin operations (e.g., in conjunction with a collaborative content creation platform or system, such as, without limitation, NVIDIA's OMNIVERSE and/or another platform, system, or service that uses USD or OpenUSD data types), systems for performing medical operations, systems for performing factory operations, systems implemented using an edge device, systems incorporating one or more virtual machines (VMs), systems for performing synthetic data generation operations (e.g., using one or more neural rendering fields (NERFs), gaussian splat techniques, diffusion models, transformer models, etc.), systems implemented at least partially in a data center, systems for performing conversational AI operations, systems implementing one or more language models-such as one or more large language models (LLMs), one or more vision language models (VLMs), one or more multi-modal language models, etc., systems for performing light transport simulation, systems for performing collaborative content creation for 3D assets (e.g., using universal scene descriptor (USD) data, such as OpenUSD, computer aided design (CAD) data, 2D and/or 3D graphics or design data, and/or other data types), systems implemented at least partially using cloud computing resources, and/or other types of systems.

In some examples, the machine learning model(s) (e.g., deep neural networks, language models, LLMs, VLMs, multi-modal language models, perception models, tracking models, fusion models, transformer models, diffusion models, encoder-only models, decoder-only models, encoder-decoder models, neural rendering field (NERF) models, etc.) described herein may be packaged as a microservice—such an inference microservice (e.g., NVIDIA NIMs)—which may include a container (e.g., an operating system (OS)-level virtualization package) that may include an application programming interface (API) layer, a server layer, a runtime layer, and/or a model “engine.” For example, the inference microservice may include the container itself and the model(s) (e.g., weights and biases). In some instances, such as where the machine learning model(s) is small enough (e.g., has a small enough number of parameters), the model(s) may be included within the container itself. In other examples—such as where the model(s) is large—the model(s) may be hosted/stored in the cloud (e.g., in a data center) and/or may be hosted on-premises and/or at the edge (e.g., on a local server or computing device, but outside of the container). In such embodiments, the model(s) may be accessible via one or more APIs-such as REST APIs. As such, and in some embodiments, the machine learning model(s) described herein may be deployed as an inference microservice to accelerate deployment of a model(s) on any cloud, data center, or edge computing system, while ensuring the data is secure. For example, the inference microservice may include one or more APIs, a pre-configured container for simplified deployment, an optimized inference engine (e.g., built using a standardized AI model deployment an execution software, such as NVIDIA's Triton Inference Server, and/or one or more APIs for high performance deep learning inference, which may include an inference runtime and model optimizations that deliver low latency and high throughput for production applications—such as NVIDIA's TensorRT), and/or enterprise management data for telemetry (e.g., including identity, metrics, health checks, and/or monitoring). The machine learning model(s) described herein may be included as part of the microservice along with an accelerated infrastructure with the ability to deploy with a single command and/or orchestrate and auto-scale with a container orchestration system on accelerated infrastructure (e.g., on a single device up to data center scale). As such, the inference microservice may include the machine learning model(s) (e.g., that has been optimized for high performance inference), an inference runtime software to execute the machine learning model(s) and provide outputs/responses to inputs (e.g., user queries, prompts, etc.), and enterprise management software to provide health checks, identity, and/or other monitoring. In some embodiments, the inference microservice may include software to perform in-place replacement and/or updating to the machine learning model(s). When replacing or updating, the software that performs the replacement/updating may maintain user configurations of the inference runtime software and enterprise management software.

In some embodiments, the system and methods described herein may be deployed in a talking or smart kiosk application. For example, a kiosk, tablet, smart display, or other device may include one or more onboard processors (e.g., CPUs, GPUs, deep learning accelerators, SoCs) and memory and/or storage (e.g., for storing the model, the image database, etc.). In some embodiments, the kiosk/tablet/display may communicate (e.g., using one or more network interface cards (NICs) and/or data processing units (DPUs)) with one or more locally hosted servers/computing devices and/or with one or more remotely located servers/computing devices (e.g., in one or more data centers). In such examples, the kiosk may communicate with the machine learning model(s) (e.g., language model, LLM, VLM, MMLM, diffusion model, transformer model, NeRF, DNN, etc.) and/or the image database hosted on the local and/or remote servers using one or more APIs—such as, without limitation, REST APIs.

In one or more embodiments, the system and methods described herein may be deployed in a gaming application. For example, a gaming console, PC, tablet, or other gaming device may include one or more onboard and/or remote processors (e.g., CPUs, GPUs, deep learning accelerators, SoCs) and memory and/or storage (e.g., for storing the game model, game assets, player data, etc.). These devices may use one or more machine learning models (e.g., diffusion models, transformer models, neural rendering field (NeRF) models, language models (e.g., LLMs, VLMs, MMLMs, etc.), DNNs, etc.) to enhance gameplay, generate real-time dynamic content, and personalize user experiences based on in-game behavior or pre-stored player profiles. In some embodiments, the system may be deployed in a cloud gaming environment (e.g., NVIDIA's GeFORCE NOW). In such cases, a client device (e.g., a smart display, tablet, or gaming controller) may be used to interact with the game, while the machine learning model(s) and/or visual rendering may occur on one or more remotely located servers/computing devices (e.g., in one or more data centers). The language model, AI processing, and rendering described herein may operate in the cloud, processing player inputs received from an end-user device(s) (e.g., based on controller, keyboard, mouse, joystick, AR/VR/MR/etc. inputs), generating appropriate in-game responses, rendering the content, and sending or transmitting the content to the end-user device(s). During receiving and/or sending the data to and from the end-user or edge device(s), one or more data processing units (DPUs) and/or network interface cards (NICs) may be used.

In some embodiments, the system and methods described herein may be deployed in a video conferencing application. For example, a video conferencing device, such as a dedicated conferencing unit, computer, tablet, and/or smartphone, may include one or more onboard processors (e.g., CPUs, GPUs, deep learning accelerators, SoCs) and memory and/or storage (e.g., for storing the video, audio, or other communication-related data). The system may use the machine learning model(s) (e.g., diffusion models, transformer models, neural rendering field (NeRF) models, language models (e.g., LLMs, VLMs, MMLMs, etc.)) to enhance video conferencing functionality, including real-time or near real-time transcription, diarization, language translation, automatic speech recognition (ASR), and/or background noise reduction. In one or more embodiments, the system may enable users to interact with the video conferencing platform using natural language inputs. For example, users may issue voice commands to schedule, join, or leave meetings, or to manage participants and screen sharing. During receiving and/or sending the data to and from the end-user or edge device(s), one or more data processing units (DPUs) and/or network interface cards (NICs) may be used.

In some embodiments, the system and methods described herein may be deployed in a robotics application. For example, a robot or robotic system may include one or more onboard processors (e.g., CPUs, GPUs, hardware-based deep learning accelerators (DLAs), hardware-based programmable vision accelerators (PVAs)—which may include one or more vector processing units (VPUs), direct memory access (DMA) systems, and/or pixel processing engines (PPEs), hardware-based optical flow accelerators (OFAs), SoCs, etc.) and memory and/or storage (e.g., for storing control algorithms, sensor data, and one or more machine learning models). The robotic system may use these processors to execute one or more machine learning models (e.g., language models) that allow it to perform complex tasks autonomously or semi-autonomously, such as interacting with and/or manipulating static and/or dynamic objects, or navigating environments using sensors such as cameras, LiDAR, RADAR, ultrasonic sensors, and more. The system may use sensor fusion techniques to combine data from multiple sensors (e.g., cameras, infrared, LiDAR, RADAR, accelerometers) to create a comprehensive model of the robot's surroundings. This data may be processed locally on the robot or sent to remote servers for more computationally intensive tasks, such as 3D mapping or SLAM (Simultaneous Localization and Mapping). In one or more embodiments, data from individual robots (e.g., sensor data, task status, or environmental conditions) may be uploaded to the cloud, where centralized AI models can analyze and distribute optimized commands to an entire fleet. In some embodiments, the machine learning model(s) (e.g., language models, VLMs, LLMs, MMLMs, diffusion models, NeRF models, DNNs, etc.) described herein may be used to allow the robot to perceive and reason about the environment and/or communicate with one or more other robots and/or persons in an environment. In some embodiments, the robot may communicate (e.g., using one or more network interface cards (NICs) and/or data processing units (DPUs)) with one or more locally hosted servers/computing devices and/or with one or more remotely located servers/computing devices (e.g., in one or more data centers).

In some embodiments, the system and methods described herein may be deployed in an in-vehicle infotainment (IVI) system or in-cabin experience (IX) application. For example, the infotainment system within a vehicle (e.g., cars, trucks, drones, construction equipment, robots, semi-autonomous vehicles, or autonomous vehicles) may include one or more onboard processors (e.g., CPUs, GPUs, hardware-based deep learning accelerators (DLAs), hardware-based programmable vision accelerators (PVAs)—which may include one or more vector processing units (VPUs), direct memory access (DMA) systems, and/or pixel processing engines (PPEs), hardware-based optical flow accelerators (OFAs), SoCs, etc.) and memory and/or storage (e.g., for storing control algorithms, sensor data, and one or more machine learning models). and memory and/or storage (e.g., for storing entertainment content, navigation data, and user preferences). The system may use these processors to execute one or more machine learning models (e.g., language models) to enable features such as voice control, personalized media recommendations, dynamic navigation, and real-time communication with other services through network connectivity. The in-vehicle infotainment system may also use natural language processing (NLP) models to enable voice-based interaction. The one or more machine learning models may be stored locally or accessed through one or more APIs that connect to cloud services, enabling the system to process requests in real time or near real-time.

Although examples may be described herein with respect to using machine learning models, such as neural networks, this is not intended to be limiting. For example, and without limitation, any of the various machine learning models and/or neural networks described herein may include any type of machine learning model, such as a machine learning model(s) using linear regression, logistic regression, decision trees, support vector machines (SVM), Naïve Bayes, k-nearest neighbor (Knn), K means clustering, random forest, dimensionality reduction algorithms, gradient boosting algorithms, neural networks (e.g., auto-encoder neural networks, artificial neural networks (ANNs), convolutional neural networks (CNNs), recurrent neural networks (RNNs), perceptrons, Long/Short Term Memory (LSTM) networks, multi-layer perceptron (MLP) netweorks, deep stacking networks (DSNs), generative pre-training (GPT) models or networks, feed forward networks, radial basis function ANNs, self-organizing maps (SOMs), Kohonen maps, Hopfield networks, Boltzmann machine, deep belief neural networks, deconvolutional neural networks, generative adversarial networks (GANs), liquid state machines, modular neural networks, liquid state machines, sequence-to-sequence models, networks using transformer architectures, diffusion models (e.g., diffusion probabilistic models, score-based generative models, etc.), neural rendering field (NeRF) models, Kolmogorov-Arnold networks (KANs), models with encoder-only architectures, models with decoder-only architectures, models with encoder-decoder architectures, generative machine learning models, language models, large language models (LLMs), vision language models (VLMs), multi-modal language models (MMLMs), etc.), and/or other types of machine learning models.

In some embodiments, one or more transformer engines (TEs) may be implemented. The transformer engine may use micro-tensor scaling to optimize performance and accuracy-such as to enable 16-bit floating point (FP16), 8-bit floting point (FP8), and/or 4-bit floating point (FP4) artificial intelligence processing. For example, the transformer engine may use 16-bit or 8-bit floating point precision and an 8-bit or 4-bit floating point data format combined with software algorithms for increasing AI performance and capabilities. By reducing math operations to 8-bits or 4-bits, the TE allows for training larger networks faster without compromising accuracy. For example, the TEs may include a library for accelerating transformer models on processing devices—such as GPUs—to provide better performance with lower memory utilization in both training and inference. When the TE is combined with other technologies, such as high-speed interconnects between nodes (e.g., using NVLink Switch) and tensor cores (which enable mixed-precision computing, such as microscaling precision support), server clusters may be more capable of training enormous networks at high speeds. As such, tensor core precisions of FP64, TF32, BF16, FP16, FP8, INT8, FP6, and FP4 may be supported, as well as CUDA core precisions of FP64, FP32, FP16, and BF16.

### Inference and Training Logic

FIG. 7A illustrates inference and/or training logic 715 used to perform inferencing and/or training operations associated with one or more embodiments.

In at least one embodiment, inference and/or training logic 715 may include, without limitation, code and/or data storage 701 to store forward and/or output weight and/or input/output data, and/or other parameters to configure neurons or layers of a neural network trained and/or used for inferencing in aspects of one or more embodiments. In at least one embodiment, training logic 715 may include, or be coupled to code and/or data storage 701 to store graph code or other software to control timing and/or order, in which weight and/or other parameter information is to be loaded to configure, logic, including integer and/or floating point units (collectively, arithmetic logic units (ALUs) or simply circuits). In at least one embodiment, code, such as graph code, loads weight or other parameter information into processor ALUs based on an architecture of a neural network to which such code corresponds. In at least one embodiment, code and/or data storage 701 stores weight parameters and/or input/output data of each layer of a neural network trained or used in conjunction with one or more embodiments during forward propagation of input/output data and/or weight parameters during training and/or inferencing using aspects of one or more embodiments. In at least one embodiment, any portion of code and/or data storage 701 may be included with other on-chip or off-chip data storage, including a processor's L1, L2, or L3 cache or system memory.

In at least one embodiment, any portion of code and/or data storage 701 may be internal or external to one or more processors or other hardware logic devices or circuits. In at least one embodiment, code and/or code and/or data storage 701 may be cache memory, dynamic randomly addressable memory (“DRAM”), static randomly addressable memory (“SRAM”), non-volatile memory (e.g., flash memory), or other storage. In at least one embodiment, a choice of whether code and/or code and/or data storage 701 is internal or external to a processor, for example, or comprising DRAM, SRAM, flash or some other storage type may depend on available storage on-chip versus off-chip, latency requirements of training and/or inferencing functions being performed, batch size of data used in inferencing and/or training of a neural network, or some combination of these factors.

In at least one embodiment, inference and/or training logic 715 may include, without limitation, a code and/or data storage 705 to store backward and/or output weight and/or input/output data corresponding to neurons or layers of a neural network trained and/or used for inferencing in aspects of one or more embodiments. In at least one embodiment, code and/or data storage 705 stores weight parameters and/or input/output data of each layer of a neural network trained or used in conjunction with one or more embodiments during backward propagation of input/output data and/or weight parameters during training and/or inferencing using aspects of one or more embodiments. In at least one embodiment, training logic 715 may include, or be coupled to code and/or data storage 705 to store graph code or other software to control timing and/or order, in which weight and/or other parameter information is to be loaded to configure, logic, including integer and/or floating point units (collectively, arithmetic logic units (ALUs).

In at least one embodiment, code, such as graph code, causes the loading of weight or other parameter information into processor ALUs based on an architecture of a neural network to which such code corresponds. In at least one embodiment, any portion of code and/or data storage 705 may be included with other on-chip or off-chip data storage, including a processor's L1, L2, or L3 cache or system memory. In at least one embodiment, any portion of code and/or data storage 705 may be internal or external to one or more processors or other hardware logic devices or circuits. In at least one embodiment, code and/or data storage 705 may be cache memory, DRAM, SRAM, non-volatile memory (e.g., flash memory), or other storage. In at least one embodiment, a choice of whether code and/or data storage 705 is internal or external to a processor, for example, or comprising DRAM, SRAM, flash memory or some other storage type may depend on available storage on-chip versus off-chip, latency requirements of training and/or inferencing functions being performed, batch size of data used in inferencing and/or training of a neural network, or some combination of these factors.

In at least one embodiment, code and/or data storage 701 and code and/or data storage 705 may be separate storage structures. In at least one embodiment, code and/or data storage 701 and code and/or data storage 705 may be a combined storage structure. In at least one embodiment, code and/or data storage 701 and code and/or data storage 705 may be partially combined and partially separate. In at least one embodiment, any portion of code and/or data storage 701 and code and/or data storage 705 may be included with other on-chip or off-chip data storage, including a processor's L1, L2, or L3 cache or system memory.

In at least one embodiment, inference and/or training logic 715 may include, without limitation, one or more arithmetic logic unit(s) (“ALU(s)”) 710, including integer and/or floating point units, to perform logical and/or mathematical operations based, at least in part on, or indicated by, training and/or inference code (e.g., graph code), a result of which may produce activations (e.g., output values from layers or neurons within a neural network) stored in an activation storage 720 that are functions of input/output and/or weight parameter data stored in code and/or data storage 701 and/or code and/or data storage 705. In at least one embodiment, activations stored in activation storage 720 are generated according to linear algebraic and or matrix-based mathematics performed by ALU(s) 710 in response to performing instructions or other code, wherein weight values stored in code and/or data storage 705 and/or data storage 701 are used as operands along with other values, such as bias values, gradient information, momentum values, or other parameters or hyperparameters, any or all of which may be stored in code and/or data storage 705 or code and/or data storage 701 or another storage on or off-chip.

In at least one embodiment, ALU(s) 710 are included within one or more processors or other hardware logic devices or circuits, whereas in another embodiment, ALU(s) 710 may be external to a processor or other hardware logic device or circuit that uses them (e.g., a coprocessor). In at least one embodiment, ALU(s) 710 may be included within a processor's execution units or otherwise within a bank of ALUs accessible by a processor's execution units either within same processor or distributed between different processors of different types (e.g., central processing units, graphics processing units, fixed function units, etc.). In at least one embodiment, code and/or data storage 701, code and/or data storage 705, and activation storage 720 may share a processor or other hardware logic device or circuit, whereas in another embodiment, they may be in different processors or other hardware logic devices or circuits, or some combination of same and different processors or other hardware logic devices or circuits. In at least one embodiment, any portion of activation storage 720 may be included with other on-chip or off-chip data storage, including a processor's L1, L2, or L3 cache or system memory. Furthermore, inferencing and/or training code may be stored with other code accessible to a processor or other hardware logic or circuit and fetched and/or processed using a processor's fetch, decode, scheduling, execution, retirement and/or other logical circuits.

In at least one embodiment, activation storage 720 may be cache memory, DRAM, SRAM, non-volatile memory (e.g., flash memory), or other storage. In at least one embodiment, activation storage 720 may be completely or partially within or external to one or more processors or other logical circuits. In at least one embodiment, a choice of whether activation storage 720 is internal or external to a processor, for example, or comprising DRAM, SRAM, flash memory or some other storage type may depend on available storage on-chip versus off-chip, latency requirements of training and/or inferencing functions being performed, batch size of data used in inferencing and/or training of a neural network, or some combination of these factors.

In at least one embodiment, inference and/or training logic 715 illustrated in FIG. 7A may be used in conjunction with an application-specific integrated circuit (“ASIC”), such as a TensorFlow® Processing Unit from Google, an inference processing unit (IPU) from Graphcore™, or a Nervana® (e.g., “Lake Crest”) processor from Intel Corp. In at least one embodiment, inference and/or training logic 715 illustrated in FIG. 7A may be used in conjunction with central processing unit (“CPU”) hardware, graphics processing unit (“GPU”) hardware or other hardware, such as field programmable gate arrays (“FPGAs”).

FIG. 7B illustrates inference and/or training logic 715, according to at least one embodiment. In at least one embodiment, inference and/or training logic 715 may include, without limitation, hardware logic in which computational resources are dedicated or otherwise exclusively used in conjunction with weight values or other information corresponding to one or more layers of neurons within a neural network. In at least one embodiment, inference and/or training logic 715 illustrated in FIG. 7B may be used in conjunction with an application-specific integrated circuit (ASIC), such as TensorFlow® Processing Unit from Google, an inference processing unit (IPU) from Graphcore™, or a Nervana® (e.g., “Lake Crest”) processor from Intel Corp. In at least one embodiment, inference and/or training logic 715 illustrated in FIG. 7B may be used in conjunction with central processing unit (CPU) hardware, graphics processing unit (GPU) hardware or other hardware, such as field programmable gate arrays (FPGAs). In at least one embodiment, inference and/or training logic 715 includes, without limitation, code and/or data storage 701 and code and/or data storage 705, which may be used to store code (e.g., graph code), weight values and/or other information, including bias values, gradient information, momentum values, and/or other parameter or hyperparameter information. In at least one embodiment illustrated in FIG. 7B, each of code and/or data storage 701 and code and/or data storage 705 is associated with a dedicated computational resource, such as computational hardware 702 and computational hardware 706, respectively. In at least one embodiment, each of computational hardware 702 and computational hardware 706 comprises one or more ALUs that perform mathematical functions, such as linear algebraic functions, only on information stored in code and/or data storage 701 and code and/or data storage 705, respectively, result of which is stored in activation storage 720.

In at least one embodiment, each of code and/or data storage 701 and 705 and corresponding computational hardware 702 and 706, respectively, correspond to different layers of a neural network, such that resulting activation from one storage/computational pair 701/702 of code and/or data storage 701 and computational hardware 702 is provided as an input to a next storage/computational pair 705/706 of code and/or data storage 705 and computational hardware 706, in order to mirror a conceptual organization of a neural network. In at least one embodiment, each of storage/computational pairs 701/702 and 705/706 may correspond to more than one neural network layer. In at least one embodiment, additional storage/computation pairs (not shown) subsequent to or in parallel with storage/computation pairs 701/702 and 705/706 may be included in inference and/or training logic 715.

### Neural Network Training and Deployment

FIG. 8 illustrates training and deployment of a deep neural network, according to at least one embodiment. In at least one embodiment, untrained neural network 806 is trained using a training dataset 802. In at least one embodiment, training framework 804 is a PyTorch framework, whereas in other embodiments, training framework 804 is a TensorFlow, Boost, Caffe, Microsoft Cognitive Toolkit/CNTK, MXNet, Chainer, Keras, Deeplearning4j, or other training framework. In at least one embodiment, training framework 804 trains an untrained neural network 806 and enables it to be trained using processing resources described herein to generate a trained neural network 808. In at least one embodiment, weights may be chosen randomly or by pre-training using a deep belief network. In at least one embodiment, training may be performed in either a supervised, partially supervised, or unsupervised manner.

In at least one embodiment, untrained neural network 806 is trained using supervised learning, wherein training dataset 802 includes an input paired with a desired output for an input, or where training dataset 802 includes input having a known output and an output of neural network 806 is manually graded. In at least one embodiment, untrained neural network 806 is trained in a supervised manner and processes inputs from training dataset 802 and compares resulting outputs against a set of expected or desired outputs. In at least one embodiment, errors are then propagated back through untrained neural network 806. In at least one embodiment, training framework 804 adjusts weights that control untrained neural network 806. In at least one embodiment, training framework 804 includes tools to monitor how well untrained neural network 806 is converging towards a model, such as trained neural network 808, suitable to generating correct answers, such as in result 814, based on input data such as a new dataset 812. In at least one embodiment, training framework 804 trains untrained neural network 806 repeatedly while adjusting weights to refine an output of untrained neural network 806 using a loss function and adjustment algorithm, such as stochastic gradient descent. In at least one embodiment, training framework 804 trains untrained neural network 806 until untrained neural network 806 achieves a desired accuracy. In at least one embodiment, trained neural network 808 can then be deployed to implement any number of machine learning operations.

In at least one embodiment, untrained neural network 806 is trained using unsupervised learning, whereas untrained neural network 806 attempts to train itself using unlabeled data. In at least one embodiment, unsupervised learning training dataset 802 will include input data without any associated output data or “ground truth” data. In at least one embodiment, untrained neural network 806 can learn groupings within training dataset 802 and can determine how individual inputs are related to untrained dataset 802. In at least one embodiment, unsupervised training can be used to generate a self-organizing map in trained neural network 808 capable of performing operations useful in reducing dimensionality of new dataset 812. In at least one embodiment, unsupervised training can also be used to perform anomaly detection, which allows identification of data points in new dataset 812 that deviate from normal patterns of new dataset 812.

In at least one embodiment, semi-supervised learning may be used, which is a technique in which in training dataset 802 includes a mix of labeled and unlabeled data. In at least one embodiment, training framework 804 may be used to perform incremental learning, such as through transferred learning techniques. In at least one embodiment, incremental learning enables trained neural network 808 to adapt to new dataset 812 without forgetting knowledge instilled within trained neural network 808 during initial training.

With reference to FIG. 9, FIG. 9 is an example data flow diagram for a process 900 of generating and deploying a processing and inferencing pipeline, according to at least one embodiment. In at least one embodiment, process 900 may be deployed to perform game name recognition analysis and inferencing on user feedback data at one or more facilities 902, such as a data center.

In at least one embodiment, process 900 may be executed within a training system 904 and/or a deployment system 906. In at least one embodiment, training system 904 may be used to perform training, deployment, and embodiment of machine learning models (e.g., neural networks, object detection algorithms, computer vision algorithms, etc.) for use in deployment system 906. In at least one embodiment, deployment system 906 may be configured to offload processing and compute resources among a distributed computing environment to reduce infrastructure requirements at facility 902. In at least one embodiment, deployment system 906 may provide a streamlined platform for selecting, customizing, and implementing virtual instruments for use with computing devices at facility 902. In at least one embodiment, virtual instruments may include software-defined applications for performing one or more processing operations with respect to feedback data. In at least one embodiment, one or more applications in a pipeline may use or call upon services (e.g., inference, visualization, compute, AI, etc.) of deployment system 906 during execution of applications.

In at least one embodiment, some applications used in advanced processing and inferencing pipelines may use machine learning models or other AI to perform one or more processing steps. In at least one embodiment, machine learning models may be trained at facility 902 using feedback data 908 (such as imaging data) stored at facility 902 or feedback data 908 from another facility or facilities, or a combination thereof. In at least one embodiment, training system 904 may be used to provide applications, services, and/or other resources for generating working, deployable machine learning models for deployment system 906.

In at least one embodiment, a model registry 924 may be backed by object storage that may support versioning and object metadata. In at least one embodiment, object storage may be accessible through, for example, a cloud storage (e.g., a cloud 1026 of FIG. 10) compatible application programming interface (API) from within a cloud platform. In at least one embodiment, machine learning models within model registry 924 may be uploaded, listed, modified, or deleted by developers or partners of a system interacting with an API. In at least one embodiment, an API may provide access to methods that allow users with appropriate credentials to associate models with applications, such that models may be executed as part of execution of containerized instantiations of applications.

In at least one embodiment, a training pipeline 1004 (FIG. 10) may include a scenario where facility 902 is training their own machine learning model, or has an existing machine learning model that needs to be optimized or updated. In at least one embodiment, feedback data 908 may be received from various channels, such as forums, web forms, or the like. In at least one embodiment, once feedback data 908 is received, AI-assisted annotation 910 may be used to aid in generating annotations corresponding to feedback data 908 to be used as ground truth data for a machine learning model. In at least one embodiment, AI-assisted annotation 910 may include one or more machine learning models (e.g., convolutional neural networks (CNNs)) that may be trained to generate annotations corresponding to certain types of feedback data 908 (e.g., from certain devices) and/or certain types of anomalies in feedback data 908. In at least one embodiment, AI-assisted annotations 910 may then be used directly, or may be adjusted or fine-tuned using an annotation tool, to generate ground truth data. In at least one embodiment, in some examples, labeled data 912 may be used as ground truth data for training a machine learning model. In at least one embodiment, AI-assisted annotations 910, labeled data 912, or a combination thereof may be used as ground truth data for training a machine learning model, e.g., via model training 914 in FIGS. 9-10. In at least one embodiment, a trained machine learning model may be referred to as an output model 916, and may be used by deployment system 906, as described herein.

In at least one embodiment, training pipeline 1004 (FIG. 10) may include a scenario where facility 902 needs a machine learning model for use in performing one or more processing tasks for one or more applications in deployment system 906, but facility 902 may not currently have such a machine learning model (or may not have a model that is optimized, efficient, or effective for such purposes). In at least one embodiment, an existing machine learning model may be selected from model registry 924. In at least one embodiment, model registry 924 may include machine learning models trained to perform a variety of different inference tasks on imaging data. In at least one embodiment, machine learning models in model registry 924 may have been trained on imaging data from different facilities than facility 902 (e.g., facilities that are remotely located). In at least one embodiment, machine learning models may have been trained on imaging data from one location, two locations, or any number of locations. In at least one embodiment, when being trained on imaging data, which may be a form of feedback data 908, from a specific location, training may take place at that location, or at least in a manner that protects confidentiality of imaging data or restricts imaging data from being transferred off-premises (e.g., to comply with HIPAA regulations, privacy regulations, etc.). In at least one embodiment, once a model is trained—or partially trained—at one location, a machine learning model may be added to model registry 924. In at least one embodiment, a machine learning model may then be retrained, or updated, at any number of other facilities, and a retrained or updated model may be made available in model registry 924. In at least one embodiment, a machine learning model may then be selected from model registry 924—and referred to as output model 916—and may be used in deployment system 906 to perform one or more processing tasks for one or more applications of a deployment system.

In at least one embodiment, training pipeline 1004 (FIG. 10) may be used in a scenario that includes facility 902 requiring a machine learning model for use in performing one or more processing tasks for one or more applications in deployment system 906, but facility 902 may not currently have such a machine learning model (or may not have a model that is optimized, efficient, or effective for such purposes). In at least one embodiment, a machine learning model selected from model registry 924 might not be fine-tuned or optimized for feedback data 908 generated at facility 902 because of differences in populations, genetic variations, robustness of training data used to train a machine learning model, diversity in anomalies of training data, and/or other issues with training data. In at least one embodiment, AI-assisted annotation 910 may be used to aid in generating annotations corresponding to feedback data 908 to be used as ground truth data for retraining or updating a machine learning model. In at least one embodiment, labeled data 912 may be used as ground truth data for training a machine learning model. In at least one embodiment, retraining or updating a machine learning model may be referred to as model training 914. In at least one embodiment, model training 914—e.g., AI-assisted annotations 910, labeled data 912, or a combination thereof—may be used as ground truth data for retraining or updating a machine learning model.

In at least one embodiment, deployment system 906 may include software 918, services 920, hardware 922, and/or other components, features, and functionality. In at least one embodiment, deployment system 906 may include a software “stack,” such that software 918 may be built on top of services 920 and may use services 920 to perform some or all of processing tasks, and services 920 and software 918 may be built on top of hardware 922 and use hardware 922 to execute processing, storage, and/or other compute tasks of deployment system 906.

In at least one embodiment, software 918 may include any number of different containers, where each container may execute an instantiation of an application. In at least one embodiment, each application may perform one or more processing tasks in an advanced processing and inferencing pipeline (e.g., inferencing, object detection, feature detection, segmentation, image enhancement, calibration, etc.). In at least one embodiment, for each type of computing device there may be any number of containers that may perform a data processing task with respect to feedback data 908 (or other data types, such as those described herein). In at least one embodiment, an advanced processing and inferencing pipeline may be defined based on selections of different containers that are desired or required for processing feedback data 908, in addition to containers that receive and configure imaging data for use by each container and/or for use by facility 902 after processing through a pipeline (e.g., to convert outputs back to a usable data type for storage and display at facility 902). In at least one embodiment, a combination of containers within software 918 (e.g., that make up a pipeline) may be referred to as a virtual instrument (as described in more detail herein), and a virtual instrument may leverage services 920 and hardware 922 to execute some or all processing tasks of applications instantiated in containers.

In at least one embodiment, data may undergo pre-processing as part of data processing pipeline to prepare data for processing by one or more applications. In at least one embodiment, post-processing may be performed on an output of one or more inferencing tasks or other processing tasks of a pipeline to prepare an output data for a next application and/or to prepare output data for transmission and/or use by a user (e.g., as a response to an inference request). In at least one embodiment, inferencing tasks may be performed by one or more machine learning models, such as trained or deployed neural networks, which may include output models 916 of training system 904.

In at least one embodiment, tasks of data processing pipeline may be encapsulated in one or more container(s) that each represent a discrete, fully functional instantiation of an application and virtualized computing environment that is able to reference machine learning models. In at least one embodiment, containers or applications may be published into a private (e.g., limited access) area of a container registry (described in more detail herein), and trained or deployed models may be stored in model registry 924 and associated with one or more applications. In at least one embodiment, images of applications (e.g., container images) may be available in a container registry, and once selected by a user from a container registry for deployment in a pipeline, an image may be used to generate a container for an instantiation of an application for use by a user system.

In at least one embodiment, developers may develop, publish, and store applications (e.g., as containers) for performing processing and/or inferencing on supplied data. In at least one embodiment, development, publishing, and/or storing may be performed using a software development kit (SDK) associated with a system (e.g., to ensure that an application and/or container developed is compliant with or compatible with a system). In at least one embodiment, an application that is developed may be tested locally (e.g., at a first facility, on data from a first facility) with an SDK which may support at least some of services 920 as a system (e.g., system 1000 of FIG. 10). In at least one embodiment, once validated by system 1000 (e.g., for accuracy, etc.), an application may be available in a container registry for selection and/or embodiment by a user (e.g., a hospital, clinic, lab, healthcare provider, etc.) to perform one or more processing tasks with respect to data at a facility (e.g., a second facility) of a user.

In at least one embodiment, developers may then share applications or containers through a network for access and use by users of a system (e.g., system 1000 of FIG. 10). In at least one embodiment, completed and validated applications or containers may be stored in a container registry and associated machine learning models may be stored in model registry 924. In at least one embodiment, a requesting entity that provides an inference or image processing request may browse a container registry and/or model registry 924 for an application, container, dataset, machine learning model, etc., select a desired combination of elements for inclusion in data processing pipeline, and submit a processing request. In at least one embodiment, a request may include input data that is necessary to perform a request, and/or may include a selection of application(s) and/or machine learning models to be executed in processing a request. In at least one embodiment, a request may then be passed to one or more components of deployment system 906 (e.g., a cloud) to perform processing of a data processing pipeline. In at least one embodiment, processing by deployment system 906 may include referencing selected elements (e.g., applications, containers, models, etc.) from a container registry and/or model registry 924. In at least one embodiment, once results are generated by a pipeline, results may be returned to a user for reference (e.g., for viewing in a viewing application suite executing on a local, on-premises workstation or terminal).

In at least one embodiment, to aid in processing or execution of applications or containers in pipelines, services 920 may be leveraged. In at least one embodiment, services 920 may include compute services, collaborative content creation services, simulation services, artificial intelligence (AI) services, visualization services, and/or other service types. In at least one embodiment, services 920 may provide functionality that is common to one or more applications in software 918, so functionality may be abstracted to a service that may be called upon or leveraged by applications. In at least one embodiment, functionality provided by services 920 may run dynamically and more efficiently, while also scaling well by allowing applications to process data in parallel, e.g., using a parallel computing platform 1030 (FIG. 10). In at least one embodiment, rather than each application that shares a same functionality offered by a service 920 being required to have a respective instance of service 920, service 920 may be shared between and among various applications. In at least one embodiment, services may include an inference server or engine that may be used for executing detection or segmentation tasks, as non-limiting examples. In at least one embodiment, a model training service may be included that may provide machine learning model training and/or retraining capabilities.

In at least one embodiment, where a service 920 includes an AI service (e.g., an inference service), one or more machine learning models associated with an application for anomaly detection (e.g., tumors, growth abnormalities, scarring, etc.) may be executed by calling upon (e.g., as an API call) an inference service (e.g., an inference server) to execute machine learning model(s), or processing thereof, as part of application execution. In at least one embodiment, where another application includes one or more machine learning models for segmentation tasks, an application may call upon an inference service to execute machine learning models for performing one or more of processing operations associated with segmentation tasks. In at least one embodiment, software 918 implementing advanced processing and inferencing pipeline may be streamlined because each application may call upon the same inference service to perform one or more inferencing tasks.

In at least one embodiment, hardware 922 may include GPUs, CPUs, graphics cards, an AI/deep learning system (e.g., an AI supercomputer, such as NVIDIA's DGX™ supercomputer system), a cloud platform, or a combination thereof. In at least one embodiment, different types of hardware 922 may be used to provide efficient, purpose-built support for software 918 and services 920 in deployment system 906. In at least one embodiment, use of GPU processing may be implemented for processing locally (e.g., at facility 902), within an AI/deep learning system, in a cloud system, and/or in other processing components of deployment system 906 to improve efficiency, accuracy, and efficacy of game name recognition.

In at least one embodiment, software 918 and/or services 920 may be optimized for GPU processing with respect to deep learning, machine learning, and/or high-performance computing, simulation, and visual computing, as non-limiting examples. In at least one embodiment, at least some of the computing environment of deployment system 906 and/or training system 904 may be executed in a datacenter or one or more supercomputers or high performance computing systems, with GPU-optimized software (e.g., hardware and software combination of NVIDIA's DGX™ system). In at least one embodiment, hardware 922 may include any number of GPUs that may be called upon to perform processing of data in parallel, as described herein. In at least one embodiment, cloud platform may further include GPU processing for GPU-optimized execution of deep learning tasks, machine learning tasks, or other computing tasks. In at least one embodiment, cloud platform (e.g., NVIDIA's NGC™) may be executed using an AI/deep learning supercomputer(s) and/or GPU-optimized software (e.g., as provided on NVIDIA's DGX™ systems) as a hardware abstraction and scaling platform. In at least one embodiment, cloud platform may integrate an application container clustering system or orchestration system (e.g., KUBERNETES) on multiple GPUs to enable seamless scaling and load balancing.

FIG. 10 is a system diagram for an example system 1000 for generating and deploying a deployment pipeline, according to at least one embodiment. In at least one embodiment, system 1000 may be used to implement process 900 of FIG. 9 and/or other processes including advanced processing and inferencing pipelines. In at least one embodiment, system 1000 may include training system 904 and deployment system 906. In at least one embodiment, training system 904 and deployment system 906 may be implemented using software 918, services 920, and/or hardware 922, as described herein.

In at least one embodiment, system 1000 (e.g., training system 904 and/or deployment system 906) may implemented in a cloud computing environment (e.g., using cloud 1026). In at least one embodiment, system 1000 may be implemented locally with respect to a facility, or as a combination of both cloud and local computing resources. In at least one embodiment, access to APIs in cloud 1026 may be restricted to authorized users through enacted security measures or protocols. In at least one embodiment, a security protocol may include web tokens that may be signed by an authentication (e.g., AuthN, AuthZ, Gluecon, etc.) service and may carry appropriate authorization. In at least one embodiment, APIs of virtual instruments (described herein), or other instantiations of system 1000, may be restricted to a set of public internet service providers (ISPs) that have been vetted or authorized for interaction.

In at least one embodiment, various components of system 1000 may communicate between and among one another using any of a variety of different network types, including but not limited to local area networks (LANs) and/or wide area networks (WANs) via wired and/or wireless communication protocols. In at least one embodiment, communication between facilities and components of system 1000 (e.g., for transmitting inference requests, for receiving results of inference requests, etc.) may be communicated over a data bus or data busses, wireless data protocols (Wi-Fi), wired data protocols (e.g., Ethernet), etc.

In at least one embodiment, training system 904 may execute training pipelines 1004, similar to those described herein with respect to FIG. 9. In at least one embodiment, where one or more machine learning models are to be used in deployment pipelines 1010 by deployment system 906, training pipelines 1004 may be used to train or retrain one or more (e.g., pre-trained) models, and/or implement one or more of pre-trained models 1006 (e.g., without a need for retraining or updating). In at least one embodiment, as a result of training pipelines 1004, output model(s) 916 may be generated. In at least one embodiment, training pipelines 1004 may include any number of processing steps, AI-assisted annotation 910, labeling or annotating of feedback data 908 to generate labeled data 912, model selection from a model registry, model training 914, training, retraining, or updating models, and/or other processing steps. In at least one embodiment, for different machine learning models used by deployment system 906, different training pipelines 1004 may be used. In at least one embodiment, training pipeline 1004, similar to a first example described with respect to FIG. 9, may be used for a first machine learning model, training pipeline 1004, similar to a second example described with respect to FIG. 9, may be used for a second machine learning model, and training pipeline 1004, similar to a third example described with respect to FIG. 9, may be used for a third machine learning model. In at least one embodiment, any combination of tasks within training system 904 may be used depending on what is required for each respective machine learning model. In at least one embodiment, one or more of machine learning models may already be trained and ready for deployment so machine learning models may not undergo any processing by training system 904, and may be implemented by deployment system 906.

In at least one embodiment, output model(s) 916 and/or pre-trained model(s) 1006 may include any types of machine learning models depending on embodiment. In at least one embodiment, and without limitation, machine learning models used by system 1000 may include machine learning model(s) using linear regression, logistic regression, decision trees, support vector machines (SVM), Naïve Bayes, k-nearest neighbor (Knn), K means clustering, random forest, dimensionality reduction algorithms, gradient boosting algorithms, neural networks (e.g., auto-encoders, convolutional, recurrent, perceptrons, Long/Short Term Memory (LSTM), Bi-LSTM, Hopfield, Boltzmann, deep belief, deconvolutional, generative adversarial, liquid state machine, etc.), and/or other types of machine learning models.

In at least one embodiment, training pipelines 1004 may include AI-assisted annotation. In at least one embodiment, labeled data 912 (e.g., traditional annotation) may be generated by any number of techniques. In at least one embodiment, labels or other annotations may be generated within a drawing program (e.g., an annotation program), a computer aided design (CAD) program, a labeling program, another type of program suitable for generating annotations or labels for ground truth, and/or may be hand drawn, in some examples. In at least one embodiment, ground truth data may be synthetically produced (e.g., generated from computer models or renderings), real produced (e.g., designed and produced from real-world data), machine-automated (e.g., using feature analysis and learning to extract features from data and then generate labels), human annotated (e.g., labeler, or annotation expert, defines location of labels), and/or a combination thereof. In at least one embodiment, for each instance of feedback data 908 (or other data type used by machine learning models), there may be corresponding ground truth data generated by training system 904. In at least one embodiment, AI-assisted annotation may be performed as part of deployment pipelines 1010; either in addition to, or in lieu of, AI-assisted annotation included in training pipelines 1004. In at least one embodiment, system 1000 may include a multi-layer platform that may include a software layer (e.g., software 918) of diagnostic applications (or other application types) that may perform one or more medical imaging and diagnostic functions.

In at least one embodiment, a software layer may be implemented as a secure, encrypted, and/or authenticated API through which applications or containers may be invoked (e.g., called) from an external environment(s), e.g., facility 902. In at least one embodiment, applications may then call or execute one or more services 920 for performing compute, AI, or visualization tasks associated with respective applications, and software 918 and/or services 920 may leverage hardware 922 to perform processing tasks in an effective and efficient manner.

In at least one embodiment, deployment system 906 may execute deployment pipelines 1010. In at least one embodiment, deployment pipelines 1010 may include any number of applications that may be sequentially, non-sequentially, or otherwise applied to feedback data (and/or other data types), including AI-assisted annotation, as described above. In at least one embodiment, as described herein, a deployment pipeline 1010 for an individual device may be referred to as a virtual instrument for a device. In at least one embodiment, for a single device, there may be more than one deployment pipeline 1010 depending on information desired from data generated by a device.

In at least one embodiment, applications available for deployment pipelines 1010 may include any application that may be used for performing processing tasks on feedback data or other data from devices. In at least one embodiment, because various applications may share common image operations, in some embodiments, a data augmentation library (e.g., as one of services 920) may be used to accelerate these operations. In at least one embodiment, to avoid bottlenecks of conventional processing approaches that rely on CPU processing, parallel computing platform 1030 may be used for GPU acceleration of these processing tasks.

In at least one embodiment, deployment system 906 may include a user interface (UI) 1014 (e.g., a graphical user interface, a web interface, etc.) that may be used to select applications for inclusion in deployment pipeline(s) 1010, arrange applications, modify or change applications or parameters or constructs thereof, use and intera with deployment pipeline(s) 1010 during set-up and/or deployment, and/or to otherwise interact with deployment system 906. In at least one embodiment, although not illustrated with respect to training system 904, UI 1014 (or a different user interface) may be used for selecting models for use in deployment system 906, for selecting models for training, or retraining, in training system 904, and/or for otherwise interacting with training system 904. In at least one embodiment, training system 904 and deployment system 906 may include DICOM adapters 1002A and 1002B.

In at least one embodiment, pipeline manager 1012 may be used, in addition to an application orchestration system 1028, to manage interaction between applications or containers of deployment pipeline(s) 1010 and services 920 and/or hardware 922. In at least one embodiment, pipeline manager 1012 may be configured to facilitate interactions from application to application, from application to service 920, and/or from application or service to hardware 922. In at least one embodiment, although illustrated as included in software 918, this is not intended to be limiting, and in some examples pipeline manager 1012 may be included in services 920. In at least one embodiment, application orchestration system 1028 (e.g., Kubernetes, DOCKER, etc.) may include a container orchestration system that may group applications into containers as logical units for coordination, management, scaling, and deployment. In at least one embodiment, by associating applications from deployment pipeline(s) 1010 (e.g., a reconstruction application, a segmentation application, etc.) with individual containers, each application may execute in a self-contained environment (e.g., at a kernel level) to increase speed and efficiency.

In at least one embodiment, each application and/or container (or image thereof) may be individually developed, modified, and deployed (e.g., a first user or developer may develop, modify, and deploy a first application and a second user or developer may develop, modify, and deploy a second application separate from a first user or developer), which may allow for focus on, and attention to, a task of a single application and/or container(s) without being hindered by tasks of other application(s) or container(s). In at least one embodiment, communication, and cooperation between different containers or applications may be aided by pipeline manager 1012 and application orchestration system 1028. In at least one embodiment, so long as an expected input and/or output of each container or application is known by a system (e.g., based on constructs of applications or containers), application orchestration system 1028 and/or pipeline manager 1012 may facilitate communication among and between, and sharing of resources among and between, each of applications or containers. In at least one embodiment, because one or more of applications or containers in deployment pipeline(s) 1010 may share the same services and resources, application orchestration system 1028 may orchestrate, load balance, and determine sharing of services or resources between and among various applications or containers. In at least one embodiment, a scheduler may be used to track resource requirements of applications or containers, current usage or planned usage of these resources, and resource availability. In at least one embodiment, the scheduler may thus allocate resources to different applications and distribute resources between and among applications in view of requirements and availability of a system. In some examples, the scheduler (and/or other component of application orchestration system 1028) may determine resource availability and distribution based on constraints imposed on a system (e.g., user constraints), such as quality of service (QoS), urgency of need for data outputs (e.g., to determine whether to execute real-time processing or delayed processing), etc.

In at least one embodiment, services 920 leveraged and shared by applications or containers in deployment system 906 may include compute services 1016, collaborative content creation services 1017, AI services 1018, simulation services 1019, visualization services 1020, and/or other service types. In at least one embodiment, applications may call (e.g., execute) one or more of services 920 to perform processing operations for an application. In at least one embodiment, compute services 1016 may be leveraged by applications to perform super-computing or other high-performance computing (HPC) tasks. In at least one embodiment, compute service(s) 1016 may be leveraged to perform parallel processing (e.g., using a parallel computing platform 1030) for processing data through one or more of applications and/or one or more tasks of a single application, substantially simultaneously. In at least one embodiment, parallel computing platform 1030 (e.g., NVIDIA's CUDA®) may enable general purpose computing on GPUs (GPGPU) (e.g., GPUs 1022). In at least one embodiment, a software layer of parallel computing platform 1030 may provide access to virtual instruction sets and parallel computational elements of GPUs, for execution of compute kernels. In at least one embodiment, parallel computing platform 1030 may include memory and, in some embodiments, a memory may be shared between and among multiple containers, and/or between and among different processing tasks within a single container. In at least one embodiment, inter-process communication (IPC) calls may be generated for multiple containers and/or for multiple processes within a container to use same data from a shared segment of memory of parallel computing platform 1030 (e.g., where multiple different stages of an application or multiple applications are processing same information). In at least one embodiment, rather than making a copy of data and moving data to different locations in memory (e.g., a read/write operation), same data in the same location of a memory may be used for any number of processing tasks (e.g., at the same time, at different times, etc.). In at least one embodiment, as data is used to generate new data as a result of processing, this information of a new location of data may be stored and shared between various applications. In at least one embodiment, location of data and a location of updated or modified data may be part of a definition of how a payload is understood within containers.

In at least one embodiment, AI services 1018 may be leveraged to perform inferencing services for executing machine learning model(s) associated with applications (e.g., tasked with performing one or more processing tasks of an application). In at least one embodiment, AI services 1018 may leverage AI system 1024 to execute machine learning model(s) (e.g., neural networks, such as CNNs) for segmentation, reconstruction, object detection, feature detection, classification, and/or other inferencing tasks. In at least one embodiment, applications of deployment pipeline(s) 1010 may use one or more of output models 916 from training system 904 and/or other models of applications to perform inference on imaging data (e.g., DICOM data, RIS data, CIS data, REST compliant data, RPC data, raw data, etc.). In at least one embodiment, two or more examples of inferencing using application orchestration system 1028 (e.g., a scheduler) may be available. In at least one embodiment, a first category may include a high priority/low latency path that may achieve higher service level agreements, such as for performing inference on urgent requests during an emergency, or for a radiologist during diagnosis. In at least one embodiment, a second category may include a standard priority path that may be used for requests that may be non-urgent or where analysis may be performed at a later time. In at least one embodiment, application orchestration system 1028 may distribute resources (e.g., services 920 and/or hardware 922) based on priority paths for different inferencing tasks of AI services 1018.

In at least one embodiment, shared storage may be mounted to AI services 1018 within system 1000. In at least one embodiment, shared storage may operate as a cache (or other storage device type) and may be used to process inference requests from applications. In at least one embodiment, when an inference request is submitted, a request may be received by a set of API instances of deployment system 906, and one or more instances may be selected (e.g., for best fit, for load balancing, etc.) to process a request. In at least one embodiment, to process a request, a request may be entered into a database, a machine learning model may be located from model registry 924 if not already in a cache, a validation step may ensure appropriate machine learning model is loaded into a cache (e.g., shared storage), and/or a copy of a model may be saved to a cache. In at least one embodiment, the scheduler (e.g., of pipeline manager 1012) may be used to launch an application that is referenced in a request if an application is not already running or if there are not enough instances of an application. In at least one embodiment, if an inference server is not already launched to execute a model, an inference server may be launched. In at least one embodiment, any number of inference servers may be launched per model. In at least one embodiment, in a pull model, in which inference servers are clustered, models may be cached whenever load balancing is advantageous. In at least one embodiment, inference servers may be statically loaded in corresponding, distributed servers.

In at least one embodiment, inferencing may be performed using an inference server that runs in a container. In at least one embodiment, an instance of an inference server may be associated with a model (and optionally a plurality of versions of a model). In at least one embodiment, if an instance of an inference server does not exist when a request to perform inference on a model is received, a new instance may be loaded. In at least one embodiment, when starting an inference server, a model may be passed to an inference server such that a same container may be used to serve different models so long as the inference server is running as a different instance.

In at least one embodiment, during application execution, an inference request for a given application may be received, and a container (e.g., hosting an instance of an inference server) may be loaded (if not already loaded), and a start procedure may be called. In at least one embodiment, pre-processing logic in a container may load, decode, and/or perform any additional pre-processing on incoming data (e.g., using a CPU(s) and/or GPU(s)). In at least one embodiment, once data is prepared for inference, a container may perform inference as necessary on data. In at least one embodiment, this may include a single inference call on one image (e.g., a hand X-ray), or may require inference on hundreds of images (e.g., a chest CT). In at least one embodiment, an application may summarize results before completing, which may include, without limitation, a single confidence score, pixel level-segmentation, voxel-level segmentation, generating a visualization, or generating text to summarize findings. In at least one embodiment, different models or applications may be assigned different priorities. For example, some models may have a real-time (turnaround time less than one minute) priority while others may have lower priority (e.g., turnaround less than 10 minutes). In at least one embodiment, model execution times may be measured from requesting institution or entity and may include partner network traversal time, as well as execution on an inference service.

In at least one embodiment, transfer of requests between services 920 and inference applications may be hidden behind a software development kit (SDK), and robust transport may be provided through a queue. In at least one embodiment, a request is placed in a queue via an API for an individual application/tenant ID combination and an SDK pulls a request from a queue and gives a request to an application. In at least one embodiment, a name of a queue may be provided in an environment from where an SDK picks up the request. In at least one embodiment, asynchronous communication through a queue may be useful as it may allow any instance of an application to pick up work as it becomes available. In at least one embodiment, results may be transferred back through a queue, to ensure no data is lost. In at least one embodiment, queues may also provide an ability to segment work, as highest priority work may go to a queue with most instances of an application connected to it, while lowest priority work may go to a queue with a single instance connected to it that processes tasks in an order received. In at least one embodiment, an application may run on a GPU-accelerated instance generated in cloud 1026, and an inference service may perform inferencing on a GPU.

In at least one embodiment, visualization services 1020 may be leveraged to generate visualizations for viewing outputs of applications and/or deployment pipeline(s) 1010. In at least one embodiment, GPUs 1022 may be leveraged by visualization services 1020 to generate visualizations. In at least one embodiment, rendering effects, such as ray-tracing or other light transport simulation techniques, may be implemented by visualization services 1020 to generate higher quality visualizations. In at least one embodiment, visualizations may include, without limitation, 2D image renderings, 3D volume renderings, 3D volume reconstruction, 2D tomographic slices, virtual reality displays, augmented reality displays, etc. In at least one embodiment, virtualized environments may be used to generate a virtual interactive display or environment (e.g., a virtual environment) for interaction by users of a system (e.g., doctors, nurses, radiologists, etc.). In at least one embodiment, visualization services 1020 may include an internal visualizer, cinematics, and/or other rendering or image processing capabilities or functionality (e.g., ray tracing, rasterization, internal optics, etc.).

In at least one embodiment, hardware 922 may include GPUs 1022, AI system 1024, cloud 1026, and/or any other hardware used for executing training system 904 and/or deployment system 906. In at least one embodiment, GPUs 1022 (e.g., NVIDIA's TESLA® and/or QUADRO® GPUs) may include any number of GPUs that may be used for executing processing tasks of compute services 1016, collaborative content creation services 1017, AI services 1018, simulation services 1019, visualization services 1020, other services, and/or any of features or functionality of software 918. For example, with respect to AI services 1018, GPUs 1022 may be used to perform pre-processing on imaging data (or other data types used by machine learning models), post-processing on outputs of machine learning models, and/or to perform inferencing (e.g., to execute machine learning models). In at least one embodiment, cloud 1026, AI system 1024, and/or other components of system 1000 may use GPUs 1022. In at least one embodiment, cloud 1026 may include a GPU-optimized platform for deep learning tasks. In at least one embodiment, AI system 1024 may use GPUs, and cloud 1026—or at least a portion tasked with deep learning or inferencing—may be executed using one or more AI systems 1024. As such, although hardware 922 is illustrated as discrete components, this is not intended to be limiting, and any components of hardware 922 may be combined with, or leveraged by, any other components of hardware 922.

In at least one embodiment, AI system 1024 may include a purpose-built computing system (e.g., a super-computer or an HPC) configured for inferencing, deep learning, machine learning, and/or other artificial intelligence tasks. In at least one embodiment, AI system 1024 (e.g., NVIDIA's DGX™) may include GPU-optimized software (e.g., a software stack) that may be executed using a plurality of GPUs 1022, in addition to CPUs, RAM, storage, and/or other components, features, or functionality. In at least one embodiment, one or more AI systems 1024 may be implemented in cloud 1026 (e.g., in a data center) for performing some or all of AI-based processing tasks of system 1000.

In at least one embodiment, cloud 1026 may include a GPU-accelerated infrastructure (e.g., NVIDIA's NGC™) that may provide a GPU-optimized platform for executing processing tasks of system 1000. In at least one embodiment, cloud 1026 may include an AI system(s) 1024 for performing one or more of AI-based tasks of system 1000 (e.g., as a hardware abstraction and scaling platform). In at least one embodiment, cloud 1026 may integrate with application orchestration system 1028 leveraging multiple GPUs to enable seamless scaling and load balancing between and among applications and services 920. In at least one embodiment, cloud 1026 may be tasked with executing at least some of services 920 of system 1000, including compute services 1016, AI services 1018, and/or visualization services 1020, as described herein. In at least one embodiment, cloud 1026 may perform small and large batch inference (e.g., executing NVIDIA's TensorRT™), provide an accelerated parallel computing API and platform 1030 (e.g., NVIDIA's CUDA®), execute application orchestration system 1028 (e.g., KUBERNETES), provide a graphics rendering API and platform (e.g., for ray-tracing, 2D graphics, 3D graphics, and/or other rendering techniques to produce higher quality cinematics), and/or may provide other functionality for system 1000.

In at least one embodiment, in an effort to preserve patient confidentiality (e.g., where patient data or records are to be used off-premises), cloud 1026 may include a registry, such as a deep learning container registry. In at least one embodiment, a registry may store containers for instantiations of applications that may perform pre-processing, post-processing, or other processing tasks on patient data. In at least one embodiment, cloud 1026 may receive data that includes patient data as well as sensor data in containers, perform requested processing for just sensor data in those containers, and then forward a resultant output and/or visualizations to appropriate parties and/or devices (e.g., on-premises medical devices used for visualization or diagnoses), all without having to extract, store, or otherwise access patient data. In at least one embodiment, confidentiality of patient data is preserved in compliance with HIPAA and/or other data regulations.

### Example Language Models

In at least some embodiments, language models, such as large language models (LLMs), vision language models (VLMs), multi-modal language models (MMLMs), and/or other types of generative artificial intelligence (AI) may be implemented. These models may be capable of understanding, summarizing, translating, and/or otherwise generating text (e.g., natural language text, code, etc.), images, video, computer aided design (CAD) assets, OMNIVERSE and/or METAVERSE file information (e.g., in USD format, such as OpenUSD), and/or the like, based on the context provided in input prompts or queries. These language models may be considered “large,” in embodiments, based on the models being trained on massive datasets and having architectures with large number of learnable network parameters (weights and biases)—such as millions or billions of parameters. The LLMs/VLMs/MMLMs/etc. may be implemented for summarizing textual data, analyzing and extracting insights from data (e.g., textual, image, video, etc.), and generating new text/image/video/etc. in user-specified styles, tones, and/or formats. The LLMs/VLMs/MMLMs/etc. of the present disclosure may be used exclusively for text processing, in embodiments, whereas in other embodiments, multi-modal LLMs may be implemented to accept, understand, and/or generate text and/or other types of content like images, audio, 2D and/or 3D data (e.g., in USD formats), and/or video. For example, vision language models (VLMs), or more generally multi-modal language models (MMLMs), may be implemented to accept image, video, audio, textual, 3D design (e.g., CAD), and/or other inputs data types and/or to generate or output image, video, audio, textual, 3D design, and/or other output data types.

Various types of LLMs/VLMs/MMLMs/etc. architectures may be implemented in various embodiments. For example, different architectures may be implemented that use different techniques for understanding and generating outputs—such as text, audio, video, image, 2D and/or 3D design or asset data, etc. In some embodiments, LLMs/VLMs/MMLMs/etc. architectures such as recurrent neural networks (RNNs) or long short-term memory networks (LSTMs) may be used, while in other embodiments transformer architectures—such as those that rely on self-attention and/or cross-attention (e.g., between contextual data and textual data) mechanisms—may be used to understand and recognize relationships between words or tokens and/or contextual data (e.g., other text, video, image, design data, USD, etc.). One or more generative processing pipelines that include LLMs/VLMs/MMLMs/etc. may also include one or more diffusion block(s) (e.g., denoisers). The LLMs/VLMs/MMLMs/etc. of the present disclosure may include encoder and/or decoder block(s). For example, discriminative or encoder-only models like BERT (Bidirectional Encoder Representations from Transformers) may be implemented for tasks that involve language comprehension such as classification, sentiment analysis, question answering, and named entity recognition. As another example, generative or decoder-only models like GPT (Generative Pretrained Transformer) may be implemented for tasks that involve language and content generation such as text completion, story generation, and dialogue generation. LLMs/VLMs/MMLMs/etc. that include both encoder and decoder components like T5 (Text-to-Text Transformer) may be implemented to understand and generate content, such as for translation and summarization. These examples are not intended to be limiting, and any architecture type—including but not limited to those described herein—may be implemented depending on the particular embodiment and the task(s) being performed using the LLMs/VLMs/MMLMs/etc.

In various embodiments, the LLMs/VLMs/MMLMs/etc. may be trained using unsupervised learning, in which an LLMs/VLMs/MMLMs/etc. learns patterns from large amounts of unlabeled text/audio/video/image/design/USD/etc. data. Due to the extensive training, in embodiments, the models may not require task-specific or domain-specific training. LLMs/VLMs/MMLMs/etc. that have undergone extensive pre-training on vast amounts of unlabeled data may be referred to as foundation models and may be adept at a variety of tasks like question-answering, summarization, filling in missing information, translation, image/video/design/USD/data generation. Some LLMs/VLMs/MMLMs/etc. may be tailored for a specific use case using techniques like prompt tuning, fine-tuning, retrieval augmented generation (RAG), adding adapters (e.g., customized neural networks, and/or neural network layers, that tune or adjust prompts or tokens to bias the language model toward a particular task or domain), and/or using other fine-tuning or tailoring techniques that optimize the models for use on particular tasks and/or within particular domains.

In some embodiments, the LLMs/VLMs/MMLMs/etc. of the present disclosure may be implemented using various model alignment techniques. For example, in some embodiments, guardrails may be implemented to identify improper or undesired inputs (e.g., prompts) and/or outputs of the models. In doing so, the system may use the guardrails and/or other model alignment techniques to either prevent a particular undesired input from being processed using the LLMs/VLMs/MMLMs/etc., and/or preventing the output or presentation (e.g., display, audio output, etc.) of information generating using the LLMs/VLMs/MMLMs/etc. In some embodiments, one or more additional models—or layers thereof—may be implemented to identify issues with inputs and/or outputs of the models. For example, these “safeguard” models may be trained to identify inputs and/or outputs that are “safe” or otherwise okay or desired and/or that are “unsafe” or are otherwise undesired for the particular application/embodiment. As a result, the LLMs/VLMs/MMLMs/etc. of the present disclosure may be less likely to output language/text/audio/video/design data/USD data/etc. that may be offensive, vulgar, improper, unsafe, out of domain, and/or otherwise undesired for the particular application/embodiment.

In some embodiments, the LLMs/VLMs/etc. may be configured to or capable of accessing or using one or more plug-ins, application programming interfaces (APIs), databases, data stores, repositories, etc. For example, for certain tasks or operations that the model is not ideally suited for, the model may have instructions (e.g., as a result of training, and/or based on instructions in a given prompt) to access one or more plug-ins (e.g., 3rd party plugins) for help in processing the current input. In such an example, where at least part of a prompt is related to restaurants or weather, the model may access one or more restaurant or weather plug-ins (e.g., via one or more APIs) to retrieve the relevant information. As another example, where at least part of a response requires a mathematical computation, the model may access one or more math plug-ins or APIs for help in solving the problem(s), and may then use the response from the plug-in and/or API in the output from the model. This process may be repeated—e.g., recursively—for any number of iterations and using any number of plug-ins and/or APIs until a response to the input prompt can be generated that addresses each ask/question/request/process/operation/etc. As such, the model(s) may not only rely on its own knowledge from training on a large dataset(s), but also on the expertise or optimized nature of one or more external resources—such as APIs, plug-ins, and/or the like.

In some embodiments, multiple language models (e.g., LLMs/VLMs/MMLMs/etc., multiple instances of the same language model, and/or multiple prompts provided to the same language model or instance of the same language model may be implemented, executed, or accessed (e.g., using one or more plug-ins, user interfaces, APIs, databases, data stores, repositories, etc.) to provide output responsive to the same query, or responsive to separate portions of a query. In at least one embodiment, multiple language models e.g., language models with different architectures, language models trained on different (e.g. updated) corpuses of data may be provided with the same input query and prompt (e.g., set of constraints, conditioners, etc.). In one or more embodiments, the language models may be different versions of the same foundation model. In one or more embodiments, at least one language model may be instantiated as multiple agents—e.g., more than one prompt may be provided to constrain, direct, or otherwise influence a style, a content, or a character, etc., of the output provided. In one or more example, non-limiting embodiments, the same language model may be asked to provide output corresponding to a different role, perspective, character, or having a different base of knowledge, etc.—as defined by a supplied prompt.

In any one of such embodiments, the output of two or more (e.g., each) language models, two or more versions of at least one language model, two or more instanced agents of at least one language model, and/or two more prompts provided to at least one language model may be further processed, e.g., aggregated, compared or filtered against, or used to determine (and provide) a consensus response. In one or more embodiments, the output from one language model—or version, instance, or agent—maybe be provided as input to another language model for further processing and/or validation. In one or more embodiments, a language model may be asked to generate or otherwise obtain an output with respect to an input source material, with the output being associated with the input source material. Such an association may include, for example, the generation of a caption or portion of text that is embedded (e.g., as metadata) with an input source text or image. In one or more embodiments, an output of a language model may be used to determine the validity of an input source material for further processing, or inclusion in a dataset. For example, a language model may be used to assess the presence (or absence) of a target word in a portion of text or an object in an image, with the text or image being annotated to note such presence (or lack thereof). Alternatively, the determination from the language model may be used to determine whether the source material should be included in a curated dataset, for example and without limitation.

FIG. 11A is a block diagram of an example generative language model system 1100 suitable for use in implementing at least some embodiments of the present disclosure. In the example illustrated in FIG. 11A, the generative language model system 1100 includes a retrieval augmented generation (RAG) component 1192, an input processor 1105, a tokenizer 1110, an embedding component 1120, plug-ins/APIs 1195, and a generative language model (LM) 1130 (which may include an LLM, a VLM, a multi-modal LM, etc.).

At a high level, the input processor 1105 may receive an input 1101 comprising text and/or other types of input data (e.g., audio data, video data, image data, sensor data (e.g., LiDAR, RADAR, ultrasonic, etc.), 3D design data, CAD data, universal scene descriptor (USD) data—such as OpenUSD, etc.), depending on the architecture of the generative LM 1130 (e.g., LLM/VLM/MMLM/etc.). In some embodiments, the input 1101 includes plain text in the form of one or more sentences, paragraphs, and/or documents. Additionally or alternatively, the input 1101 may include numerical sequences, precomputed embeddings (e.g., word or sentence embeddings), and/or structured data (e.g., in tabular formats, JSON, or XML). In some embodiments in which the generative LM 1130 is capable of processing multi-modal inputs, the input 1101 may combine text (or may omit text) with image data, audio data, video data, design data, USD data, and/or other types of input data, such as but not limited to those described herein. Taking raw input text as an example, the input processor 1105 may prepare raw input text in various ways. For example, the input processor 1105 may perform various types of text filtering to remove noise (e.g., special characters, punctuation, HTML tags, stopwords, portions of an image(s), portions of audio, etc.) from relevant textual content. In an example involving stopwords (common words that tend to carry little semantic meaning), the input processor 1105 may remove stopwords to reduce noise and focus the generative LM 1130 on more meaningful content. The input processor 1105 may apply text normalization, for example, by converting all characters to lowercase, removing accents, and/or or handling special cases like contractions or abbreviations to ensure consistency. These are just a few examples, and other types of input processing may be applied.

In some embodiments, a RAG component 1192 (which may include one or more RAG models, and/or may be performed using the generative LM 1130 itself) may be used to retrieve additional information to be used as part of the input 1101 or prompt. RAG may be used to enhance the input to the LLM/VLM/MMLM/etc. with external knowledge, so that answers to specific questions or queries or requests are more relevant—such as in a case where specific knowledge is required. The RAG component 1192 may fetch this additional information (e.g., grounding information, such as grounding text/image/video/audio/USD/CAD/etc.) from one or more external sources, which can then be fed to the LLM/VLM/MMLM/etc. along with the prompt to improve accuracy of the responses or outputs of the model.

For example, in some embodiments, the input 1101 may be generated using the query or input to the model (e.g., a question, a request, etc.) in addition to data retrieved using the RAG component 1192. In some embodiments, the input processor 1105 may analyze the input 1101 and communicate with the RAG component 1192 (or the RAG component 1192 may be part of the input processor 1105, in embodiments) in order to identify relevant text and/or other data to provide to the generative LM 1130 as additional context or sources of information from which to identify the response, answer, or output 1190, generally. For example, where the input indicates that the user is interested in a desired tire pressure for a particular make and model of vehicle, the RAG component 1192 may retrieve—using a RAG model performing a vector search in an embedding space, for example—the tire pressure information or the text corresponding thereto from a digital (embedded) version of the user manual for that particular vehicle make and model. Similarly, where a user revisits a chatbot related to a particular product offering or service, the RAG component 1192 may retrieve a prior stored conversation history—or at least a summary thereof—and include the prior conversation history along with the current ask/request as part of the input 1101 to the generative LM 1130.

The RAG component 1192 may use various RAG techniques. For example, naïve RAG may be used where documents are indexed, chunked, and applied to an embedding model to generate embeddings corresponding to the chunks. A user query may also be applied to the embedding model and/or another embedding model of the RAG component 1192 and the embeddings of the chunks along with the embeddings of the query may be compared to identify the most similar/related embeddings to the query, which may be supplied to the generative LM 1130 to generate an output.

In some embodiments, more advanced RAG techniques may be used. For example, prior to passing chunks to the embedding model, the chunks may undergo pre-retrieval processes (e.g., routing, rewriting, metadata analysis, expansion, etc.). In addition, prior to generating the final embeddings, post-retrieval processes (e.g., re-ranking, prompt compression, etc.) may be performed on the outputs of the embedding model prior to final embeddings being used as comparison to an input query.

As a further example, modular RAG techniques may be used, such as those that are similar to naïve and/or advanced RAG, but also include features such as hybrid search, recursive retrieval and query engines, StepBack approaches, sub-queries, and hypothetical document embedding.

As another example, Graph RAG may use knowledge graphs as a source of context or factual information. Graph RAG may be implemented using a graph database as a source of contextual information sent to the LLM/VLM/MMLM/etc. Rather than (or in addition to) providing the model with chunks of data extracted from larger sized documents-which may result in a lack of context, factual correctness, language accuracy, etc.—graph RAG may also provide structured entity information to the LLM/VLM/MMLM/etc. by combining the structured entity textual description with its many properties and relationships, allowing for deeper insights by the model. When implementing graph RAG, the systems and methods described herein use a graph as a content store and extract relevant chunks of documents and ask the LLM/VLM/MMLM/etc. to answer using them. The knowledge graph, in such embodiments, may contain relevant textual content and metadata about the knowledge graph as well as be integrated with a vector database. In some embodiments, the graph RAG may use a graph as a subject matter expert, where descriptions of concepts and entities relevant to a query/prompt may be extracted and passed to the model as semantic context. These descriptions may include relationships between the concepts. In other examples, the graph may be used as a database, where part of a query/prompt may be mapped to a graph query, the graph query may be executed, and the LLM/VLM/MMLM/etc. may summarize the results. In such an example, the graph may store relevant factual information, and a query (natural language query) to graph query tool (NL-to-Graph-query tool) and entity linking may be used. In some embodiments, graph RAG (e.g., using a graph database) may be combined with standard (e.g., vector database) RAG, and/or other RAG types, to benefit from multiple approaches.

In any embodiments, the RAG component 1192 may implement a plugin, API, user interface, and/or other functionality to perform RAG. For example, a graph RAG plug-in may be used by the LLM/VLM/MMLM/etc. to run queries against the knowledge graph to extract relevant information for feeding to the model, and a standard or vector RAG plug-in may be used to run queries against a vector database. For example, the graph database may interact with a plug-in's REST interface such that the graph database is decoupled from the vector database and/or the embeddings models.

The tokenizer 1110 may segment the (e.g., processed) text data into smaller units (tokens) for subsequent analysis and processing. The tokens may represent individual words, subwords, characters, portions of audio/video/image/etc., depending on the embodiment. Word-based tokenization divides the text into individual words, treating each word as a separate token. Subword tokenization breaks down words into smaller meaningful units (e.g., prefixes, suffixes, stems), enabling the generative LM 1130 to understand morphological variations and handle out-of-vocabulary words more effectively. Character-based tokenization represents each character as a separate token, enabling the generative LM 1130 to process text at a fine-grained level. The choice of tokenization strategy may depend on factors such as the language being processed, the task at hand, and/or characteristics of the training dataset. As such, the tokenizer 1110 may convert the (e.g., processed) text into a structured format according to tokenization schema being implemented in the particular embodiment.

The embedding component 1120 may use any known embedding technique to transform discrete tokens into (e.g., dense, continuous vector) representations of semantic meaning. For example, the embedding component 1120 may use pre-trained word embeddings (e.g., Word2Vec, GloVe, or FastText), one-hot encoding, Term Frequency-Inverse Document Frequency (TF-IDF) encoding, one or more embedding layers of a neural network, and/or otherwise.

In some embodiments in which the input 1101 includes image data/video data/etc., the input processor 1101 may resize the data to a standard size compatible with format of a corresponding input channel and/or may normalize pixel values to a common range (e.g., 0 to 1) to ensure a consistent representation, and the embedding component 1120 may encode the image data using any known technique (e.g., using one or more convolutional neural networks (CNNs) to extract visual features). In some embodiments in which the input 1101 includes audio data, the input processor 1101 may resample an audio file to a consistent sampling rate for uniform processing, and the embedding component 1120 may use any known technique to extract and encode audio features—such as in the form of a spectrogram (e.g., a mel-spectrogram). In some embodiments in which the input 1101 includes video data, the input processor 1101 may extract frames or apply resizing to extracted frames, and the embedding component 1120 may extract features such as optical flow embeddings or video embeddings and/or may encode temporal information or sequences of frames. In some embodiments in which the input 1101 includes multi-modal data, the embedding component 1120 may fuse representations of the different types of data (e.g., text, image, audio, USD, video, design, etc.) using techniques like early fusion (concatenation), late fusion (sequential processing), attention-based fusion (e.g., self-attention, cross-attention), etc.

The generative LM 1130 and/or other components of the generative LM system 1100 may use different types of neural network architectures depending on the embodiment. For example, transformer-based architectures such as those used in models like GPT may be implemented, and may include self-attention mechanisms that weigh the importance of different words or tokens in the input sequence and/or feedforward networks that process the output of the self-attention layers, applying non-linear transformations to the input representations and extracting higher-level features. Some non-limiting example architectures include transformers (e.g., encoder-decoder, decoder only, multi-modal), RNNs, LSTMs, fusion models, diffusion models, cross-modal embedding models that learn joint embedding spaces, graph neural networks (GNNs), hybrid architectures combining different types of architectures adversarial networks like generative adversarial networks or GANs or adversarial autoencoders (AAEs) for joint distribution learning, and others. As such, depending on the embodiment and architecture, the embedding component 1120 may apply an encoded representation of the input 1101 to the generative LM 1130, and the generative LM 1130 may process the encoded representation of the input 1101 to generate an output 1190, which may include responsive text and/or other types of data.

As described herein, in some embodiments, the generative LM 1130 may be configured to access or use—or capable of accessing or using-plug-ins/APIs 1195 (which may include one or more plug-ins, application programming interfaces (APIs), databases, data stores, repositories, etc.). For example, for certain tasks or operations that the generative LM 1130 is not ideally suited for, the model may have instructions (e.g., as a result of training, and/or based on instructions in a given prompt, such as those retrieved using the RAG component 1192) to access one or more plug-ins/APIs 1195 (e.g., 3^{rd} party plugins) for help in processing the current input. In such an example, where at least part of a prompt is related to restaurants or weather, the model may access one or more restaurant or weather plug-ins (e.g., via one or more APIs), send at least a portion of the prompt related to the particular plug-in/API 1195 to the plug-in/API 1195, the plug-in/API 1195 may process the information and return an answer to the generative LM 1130, and the generative LM 1130 may use the response to generate the output 1190. This process may be repeated—e.g., recursively—for any number of iterations and using any number of plug-ins/APIs 1195 until an output 1190 that addresses each ask/question/request/process/operation/etc. from the input 1101 can be generated. As such, the model(s) may not only rely on its own knowledge from training on a large dataset(s) and/or from data retrieved using the RAG component 1192, but also on the expertise or optimized nature of one or more external resources—such as the plug-ins/APIs 1195.

FIG. 11B is a block diagram of an example embodiment in which the generative LM 1130 includes a transformer encoder-decoder. For example, assume input text such as “Who discovered gravity” is tokenized (e.g., by the tokenizer 1110 of FIG. 11A) into tokens such as words, and each token is encoded (e.g., by the embedding component 1120 of FIG. 911A) into a corresponding embedding (e.g., of size 512). Since these token embeddings typically do not represent the position of the token in the input sequence, any known technique may be used to add a positional encoding to each token embedding to encode the sequential relationships and context of the tokens in the input sequence. As such, the (e.g., resulting) embeddings may be applied to one or more encoder(s) 1135 of the generative LM 1130.

In an example embodiment, the encoder(s) 1135 forms an encoder stack, where each encoder includes a self-attention layer and a feedforward network. In an example transformer architecture, each token (e.g., word) flows through a separate path. As such, each encoder may accept a sequence of vectors, passing each vector through the self-attention layer, then the feedforward network, and then upwards to the next encoder in the stack. Any known self-attention technique may be used. For example, to calculate a self-attention score for each token (word), a query vector, a key vector, and a value vector may be created for each token, a self-attention score may be calculated for pairs of tokens by taking the dot product of the query vector with the corresponding key vectors, normalizing the resulting scores, multiplying by corresponding value vectors, and summing weighted value vectors. The encoder may apply multi-headed attention in which the attention mechanism is applied multiple times in parallel with different learned weight matrices. Any number of encoders may be cascaded to generate a context vector encoding the input. An attention projection layer 1140 may convert the context vector into attention vectors (keys and values) for the decoder(s) 1145.

In an example embodiment, the decoder(s) 1145 form a decoder stack, where each decoder includes a self-attention layer, an encoder-decoder self-attention layer that uses the attention vectors (keys and values) from the encoder to focus on relevant parts of the input sequence, and a feedforward network. As with the encoder(s) 1135, in an example transformer architecture, each token (e.g., word) flows through a separate path in the decoder(s) 1145. During a first pass, the decoder(s) 1145, a classifier 1150, and a generation mechanism 1155 may generate a first token, and the generation mechanism 1155 may apply the generated token as an input during a second pass. The process may repeat in a loop, successively generating and adding tokens (e.g., words) to the output from the preceding pass and applying the token embeddings of the composite sequence with positional encodings as an input to the decoder(s) 1145 during a subsequent pass, sequentially generating one token at a time (known as auto-regression) until predicting a symbol or token that represents the end of the response. Within each decoder, the self-attention layer is typically constrained to attend only to preceding positions in the output sequence by applying a masking technique (e.g., setting future positions to negative infinity) before the softmax operation. In an example embodiment, the encoder-decoder attention layer operates similarly to the (e.g., multi-headed) self-attention in the encoder(s) 1135, except that it creates its queries from the layer below it and takes the keys and values (e.g., matrix) from the output of the encoder(s) 1135.

As such, the decoder(s) 1145 may output some decoded (e.g., vector) representation of the input being applied during a particular pass. The classifier 1150 may include a multi-class classifier comprising one or more neural network layers that project the decoded (e.g., vector) representation into a corresponding dimensionality (e.g., one dimension for each supported word or token in the output vocabulary) and a softmax operation that converts logits to probabilities. As such, the generation mechanism 1155 may select or sample a word or token based on a corresponding predicted probability (e.g., select the word with the highest predicted probability) and append it to the output from a previous pass, generating each word or token sequentially. The generation mechanism 1155 may repeat the process, triggering successive decoder inputs and corresponding predictions until selecting or sampling a symbol or token that represents the end of the response, at which point, the generation mechanism 1155 may output the generated response.

FIG. 11C is a block diagram of an example embodiment in which the generative LM 1130 includes a decoder-only transformer architecture. For example, the decoder(s) 1160 of FIG. 11C may operate similarly as the decoder(s) 1145 of FIG. 11B except each of the decoder(s) 1160 of FIG. 11C omits the encoder-decoder self-attention layer (since there is no encoder in this embodiment). As such, the decoder(s) 1160 may form a decoder stack, where each decoder includes a self-attention layer and a feedforward network. Furthermore, instead of encoding the input sequence, a symbol or token representing the end of the input sequence (or the beginning of the output sequence) may be appended to the input sequence, and the resulting sequence (e.g., corresponding embeddings with positional encodings) may be applied to the decoder(s) 1160. As with the decoder(s) 1145 of FIG. 11B, each token (e.g., word) may flow through a separate path in the decoder(s) 1160, and the decoder(s) 1160, a classifier 1165, and a generation mechanism 1170 may use auto-regression to sequentially generate one token at a time until predicting a symbol or token that represents the end of the response. The classifier 1165 and the generation mechanism 1170 may operate similarly as the classifier 1150 and the generation mechanism 1155 of FIG. 11B, with the generation mechanism 1170 selecting or sampling each successive output token based on a corresponding predicted probability and appending it to the output from a previous pass, generating each token sequentially until selecting or sampling a symbol or token that represents the end of the response. These and other architectures described herein are meant simply as examples, and other suitable architectures may be implemented within the scope of the present disclosure.

### Example Computing Device

FIG. 12 is a block diagram of an example computing device(s) 1200 suitable for use in implementing some embodiments of the present disclosure. Computing device 1200 may include an interconnect system 1202 that directly or indirectly couples the following devices: memory 1204, one or more central processing units (CPUs) 1206, one or more graphics processing units (GPUs) 1208, a communication interface 1210, input/output (I/O) ports 1212, input/output components 1214, a power supply 1216, one or more presentation components 1218 (e.g., display(s)), and one or more logic units 1220. In at least one embodiment, the computing device(s) 1200 may comprise one or more virtual machines (VMs), and/or any of the components thereof may comprise virtual components (e.g., virtual hardware components). For non-limiting examples, one or more of the GPUs 1208 may comprise one or more vGPUs, one or more of the CPUs 1206 may comprise one or more vCPUs, and/or one or more of the logic units 1220 may comprise one or more virtual logic units. As such, a computing device(s) 1200 may include discrete components (e.g., a full GPU dedicated to the computing device 1200), virtual components (e.g., a portion of a GPU dedicated to the computing device 1200), or a combination thereof.

Although the various blocks of FIG. 12 are shown as connected via the interconnect system 1202 with lines, this is not intended to be limiting and is for clarity only. For example, in some embodiments, a presentation component 1218, such as a display device, may be considered an I/O component 1214 (e.g., if the display is a touch screen). As another example, the CPUs 1206 and/or GPUs 1208 may include memory (e.g., the memory 1204 may be representative of a storage device in addition to the memory of the GPUs 1208, the CPUs 1206, and/or other components). As such, the computing device of FIG. 12 is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 12.

The interconnect system 1202 may represent one or more links or busses, such as an address bus, a data bus, a control bus, or a combination thereof. The interconnect system 1202 may include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, and/or another type of bus or link. In some embodiments, there are direct connections between components. As an example, the CPU 1206 may be directly connected to the memory 1204. Further, the CPU 1206 may be directly connected to the GPU 1208. Where there is direct, or point-to-point connection between components, the interconnect system 1202 may include a PCIe link to carry out the connection. In these examples, a PCI bus need not be included in the computing device 1200.

The memory 1204 may include any of a variety of computer-readable media. The computer-readable media may be any available media that may be accessed by the computing device 1200. The computer-readable media may include both volatile and nonvolatile media, and removable and non-removable media. By way of example, and not limitation, the computer-readable media may comprise computer-storage media and communication media.

The computer-storage media may include both volatile and nonvolatile media and/or removable and non-removable media implemented in any method or technology for storage of information such as computer-readable instructions, data structures, program modules, and/or other data types. For example, the memory 1204 may store computer-readable instructions (e.g., that represent a program(s) and/or a program element(s), such as an operating system. Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by computing device 1200. As used herein, computer storage media does not comprise signals per se.

The computer storage media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the computer storage media may include wired media such as a wired network or direct-wired connection, and wireless media such as acoustic, RF, infrared and other wireless media. Combinations of any of the above should also be included within the scope of computer-readable media.

The CPU(s) 1206 may be configured to execute at least some of the computer-readable instructions to control one or more components of the computing device 1200 to perform one or more of the methods and/or processes described herein. The CPU(s) 1206 may each include one or more cores (e.g., one, two, four, eight, twenty-eight, seventy-two, etc.) that are capable of handling a multitude of software threads simultaneously. The CPU(s) 1206 may include any type of processor, and may include different types of processors depending on the type of computing device 1200 implemented (e.g., processors with fewer cores for mobile devices and processors with more cores for servers). For example, depending on the type of computing device 1200, the processor may be an Advanced RISC Machines (ARM) processor implemented using Reduced Instruction Set Computing (RISC) or an x86 processor implemented using Complex Instruction Set Computing (CISC). The computing device 1200 may include one or more CPUs 1206 in addition to one or more microprocessors or supplementary co-processors, such as math co-processors.

In addition to or alternatively from the CPU(s) 1206, the GPU(s) 1208 may be configured to execute at least some of the computer-readable instructions to control one or more components of the computing device 1200 to perform one or more of the methods and/or processes described herein. One or more of the GPU(s) 1208 may be an integrated GPU (e.g., with one or more of the CPU(s) 1206 and/or one or more of the GPU(s) 1208 may be a discrete GPU. In embodiments, one or more of the GPU(s) 1208 may be a coprocessor of one or more of the CPU(s) 1206. The GPU(s) 1208 may be used by the computing device 1200 to render graphics (e.g., 3D graphics) or perform general purpose computations. For example, the GPU(s) 1208 may be used for General-Purpose computing on GPUs (GPGPU). The GPU(s) 1208 may include hundreds or thousands of cores that are capable of handling hundreds or thousands of software threads simultaneously. The GPU(s) 1208 may generate pixel data for output images in response to rendering commands (e.g., rendering commands from the CPU(s) 1206 received via a host interface). The GPU(s) 1208 may include graphics memory, such as display memory, for storing pixel data or any other suitable data, such as GPGPU data. The display memory may be included as part of the memory 1204. The GPU(s) 1208 may include two or more GPUs operating in parallel (e.g., via a link). The link may directly connect the GPUs (e.g., using NVLINK) or may connect the GPUs through a switch (e.g., using NVSwitch). When combined together, each GPU 1208 may generate pixel data or GPGPU data for different portions of an output or for different outputs (e.g., a first GPU for a first image and a second GPU for a second image). Each GPU may include its own memory, or may share memory with other GPUs.

In addition to or alternatively from the CPU(s) 1206 and/or the GPU(s) 1208, the logic unit(s) 1220 may be configured to execute at least some of the computer-readable instructions to control one or more components of the computing device 1200 to perform one or more of the methods and/or processes described herein. In embodiments, the CPU(s) 1206, the GPU(s) 1208, and/or the logic unit(s) 1220 may discretely or jointly perform any combination of the methods, processes and/or portions thereof. One or more of the logic units 1220 may be part of and/or integrated in one or more of the CPU(s) 1206 and/or the GPU(s) 1208 and/or one or more of the logic units 1220 may be discrete components or otherwise external to the CPU(s) 1206 and/or the GPU(s) 1208. In embodiments, one or more of the logic units 1220 may be a coprocessor of one or more of the CPU(s) 1206 and/or one or more of the GPU(s) 1208.

Examples of the logic unit(s) 1220 include one or more processing cores and/or components thereof, such as Data Processing Units (DPUs), Tensor Cores (TCs), Tensor Processing Units (TPUs), Pixel Visual Cores (PVCs), Vision Processing Units (VPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Programmable Vision Accelerator (PVAs)—which may include one or more direct memory access (DMA) systems, one or more vision or vector processing units (VPUs), one or more pixel processing engines (PPEs), one or more decoupled accelerators (e.g., decoupled lookup table (DLUT) accelerators), etc., Vision Processing Units (VPUs), Optical Flow Accelerators (OFAs), Field Programmable Gate Arrays (FPGAs), Neuromorphic Chips, Quantum Processing Units (QPUs), Associative Process Units (APUs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The communication interface 1210 may include one or more receivers, transmitters, and/or transceivers that allow the computing device 1200 to communicate with other computing devices via an electronic communication network, included wired and/or wireless communications. The communication interface 1210 may include components and functionality to allow communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet. In one or more embodiments, logic unit(s) 1220 and/or communication interface 1210 may include one or more data processing units (DPUs) to transmit data received over a network and/or through interconnect system 1202 directly to (e.g., a memory of) one or more GPU(s) 1208.

The I/O ports 1212 may allow the computing device 1200 to be logically coupled to other devices including the I/O components 1214, the presentation component(s) 1218, and/or other components, some of which may be built in to (e.g., integrated in) the computing device 1200. Illustrative I/O components 1214 include a microphone, mouse, keyboard, joystick, game pad, game controller, satellite dish, scanner, printer, wireless device, etc. The I/O components 1214 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the computing device 1200. The computing device 1200 may be include depth cameras, such as stereoscopic camera systems, infrared camera systems, RGB camera systems, touchscreen technology, and combinations of these, for gesture detection and recognition. Additionally, the computing device 1200 may include accelerometers or gyroscopes (e.g., as part of an inertia measurement unit (IMU)) that allow detection of motion. In some examples, the output of the accelerometers or gyroscopes may be used by the computing device 1200 to render immersive augmented reality or virtual reality.

The power supply 1216 may include a hard-wired power supply, a battery power supply, or a combination thereof. The power supply 1216 may provide power to the computing device 1200 to allow the components of the computing device 1200 to operate.

The presentation component(s) 1218 may include a display (e.g., a monitor, a touch screen, a television screen, a heads-up-display (HUD), other display types, or a combination thereof), speakers, and/or other presentation components. The presentation component(s) 1218 may receive data from other components (e.g., the GPU(s) 1208, the CPU(s) 1206, DPUs, etc.), and output the data (e.g., as an image, video, sound, etc.).

### Example Data Center

FIG. 13 illustrates an example data center 1300 that may be used in at least one embodiments of the present disclosure. The data center 1300 may include a data center infrastructure layer 1310, a framework layer 1320, a software layer 1330, and/or an application layer 1340.

As shown in FIG. 13, the data center infrastructure layer 1310 may include a resource orchestrator 1312, grouped computing resources 1314, and node computing resources (“node C.R.s”) 1316(1)-1316(N), where “N” represents any whole, positive integer. In at least one embodiment, node C.R.s 1316(1)-1316(N) may include, but are not limited to, any number of central processing units (CPUs) or other processors (including DPUs, accelerators, field programmable gate arrays (FPGAs), graphics processors or graphics processing units (GPUs), etc.), memory devices (e.g., dynamic read-only memory), storage devices (e.g., solid state or disk drives), network input/output (NW I/O) devices, network switches, virtual machines (VMs), power modules, and/or cooling modules, etc. In some embodiments, one or more node C.R.s from among node C.R.s 1316(1)-1316(N) may correspond to a server having one or more of the above-mentioned computing resources. In addition, in some embodiments, the node C.R.s 1316(1)-13161(N) may include one or more virtual components, such as vGPUs, vCPUs, and/or the like, and/or one or more of the node C.R.s 1316(1)-1316(N) may correspond to a virtual machine (VM).

In at least one embodiment, grouped computing resources 1314 may include separate groupings of node C.R.s 1316 housed within one or more racks (not shown), or many racks housed in data centers at various geographical locations (also not shown). Separate groupings of node C.R.s 1316 within grouped computing resources 1314 may include grouped compute, network, memory or storage resources that may be configured or allocated to support one or more workloads. In at least one embodiment, several node C.R.s 1316 including CPUs, GPUS, DPUs, and/or other processors may be grouped within one or more racks to provide compute resources to support one or more workloads. The one or more racks may also include any number of power modules, cooling modules, and/or network switches, in any combination.

The resource orchestrator 1312 may configure or otherwise control one or more node C.R.s 1316(1)-1316(N) and/or grouped computing resources 1314. In at least one embodiment, resource orchestrator 1312 may include a software design infrastructure (SDI) management entity for the data center 1300. The resource orchestrator 1312 may include hardware, software, or some combination thereof.

In at least one embodiment, as shown in FIG. 13, framework layer 1320 may include a job scheduler 1328, a configuration manager 1334, a resource manager 1336, and/or a distributed file system 1338. The framework layer 1320 may include a framework to support software 1332 of software layer 1330 and/or one or more application(s) 1342 of application layer 1340. The software 1332 or application(s) 1342 may respectively include web-based service software or applications, such as those provided by Amazon Web Services, Google Cloud and Microsoft Azure. The framework layer 1320 may be, but is not limited to, a type of free and open-source software web application framework such as Apache Spark™ (hereinafter “Spark”) that may use distributed file system 1338 for large-scale data processing (e.g., “big data”). In at least one embodiment, job scheduler 1328 may include a Spark driver to facilitate scheduling of workloads supported by various layers of data center 1300. The configuration manager 1334 may be capable of configuring different layers such as software layer 1330 and framework layer 1320 including Spark and distributed file system 1338 for supporting large-scale data processing. The resource manager 1336 may be capable of managing clustered or grouped computing resources mapped to or allocated for support of distributed file system 1338 and job scheduler 1328. In at least one embodiment, clustered or grouped computing resources may include grouped computing resource 1314 at data center infrastructure layer 1310. The resource manager 1336 may coordinate with resource orchestrator 1312 to manage these mapped or allocated computing resources.

In at least one embodiment, software 1332 included in software layer 1330 may include software used by at least portions of node C.R.s 1316(1)-1316(N), grouped computing resources 1314, and/or distributed file system 1338 of framework layer 1320. One or more types of software may include, but are not limited to, Internet web page search software, e-mail virus scan software, database software, and streaming video content software.

In at least one embodiment, application(s) 1342 included in application layer 1340 may include one or more types of applications used by at least portions of node C.R.s 1316(1)-1316 (N), grouped computing resources 1314, and/or distributed file system 1338 of framework layer 1320. One or more types of applications may include, but are not limited to, any number of a genomics application, a cognitive compute, and a machine learning application, including training or inferencing software, machine learning framework software (e.g., PyTorch, TensorFlow, Caffe, etc.), and/or other machine learning applications used in conjunction with one or more embodiments.

In at least one embodiment, any of configuration manager 1334, resource manager 1336, and resource orchestrator 1312 may implement any number and type of self-modifying actions based on any amount and type of data acquired in any technically feasible fashion. Self-modifying actions may relieve a data center operator of data center 1300 from making possibly bad configuration decisions and possibly avoiding underutilized and/or poor performing portions of a data center.

The data center 1300 may include tools, services, software or other resources to train one or more machine learning models or predict or infer information using one or more machine learning models according to one or more embodiments described herein. For example, a machine learning model(s) may be trained by calculating weight parameters according to a neural network architecture using software and/or computing resources described above with respect to the data center 1300. In at least one embodiment, trained or deployed machine learning models corresponding to one or more neural networks may be used to infer or predict information using resources described above with respect to the data center 1300 by using weight parameters calculated through one or more training techniques, such as but not limited to those described herein.

In at least one embodiment, the data center 1300 may use CPUs, application-specific integrated circuits (ASICs), GPUs, FPGAs, and/or other hardware (or virtual compute resources corresponding thereto) to perform training and/or inferencing using above-described resources. Moreover, one or more software and/or hardware resources described above may be configured as a service to allow users to train or performing inferencing of information, such as image recognition, speech recognition, or other artificial intelligence services.

### Example Network Environments

Network environments suitable for use in implementing embodiments of the disclosure may include one or more client devices, servers, network attached storage (NAS), other backend devices, and/or other device types. The client devices, servers, and/or other device types (e.g., each device) may be implemented on one or more instances of the computing device(s) 1200 of FIG. 12—e.g., each device may include similar components, features, and/or functionality of the computing device(s) 1200. In addition, where backend devices (e.g., servers, NAS, etc.) are implemented, the backend devices may be included as part of a data center 1300, an example of which is described in more detail herein with respect to FIG. 13.

Components of a network environment may communicate with each other via a network(s), which may be wired, wireless, or both. The network may include multiple networks, or a network of networks. By way of example, the network may include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) may provide wireless connectivity.

Compatible network environments may include one or more peer-to-peer network environments—in which case a server may not be included in a network environment—and one or more client-server network environments—in which case one or more servers may be included in a network environment. In peer-to-peer network environments, functionality described herein with respect to a server(s) may be implemented on any number of client devices.

In at least one embodiment, a network environment may include one or more cloud-based network environments, a distributed computing environment, a combination thereof, etc. A cloud-based network environment may include a framework layer, a job scheduler, a resource manager, and a distributed file system implemented on one or more of servers, which may include one or more core network servers and/or edge servers. A framework layer may include a framework to support software of a software layer and/or one or more application(s) of an application layer. The software or application(s) may respectively include web-based service software or applications. In embodiments, one or more of the client devices may use the web-based service software or applications (e.g., by accessing the service software and/or applications via one or more application programming interfaces (APIs)). The framework layer may be, but is not limited to, a type of free and open-source software web application framework such as that may use a distributed file system for large-scale data processing (e.g., “big data”).

A cloud-based network environment may provide cloud computing and/or cloud storage that carries out any combination of computing and/or data storage functions described herein (or one or more portions thereof). Any of these various functions may be distributed over multiple locations from central or core servers (e.g., of one or more data centers that may be distributed across a state, a region, a country, the globe, etc.). If a connection to a user (e.g., a client device) is relatively close to an edge server(s), a core server(s) may designate at least a portion of the functionality to the edge server(s). A cloud-based network environment may be private (e.g., limited to a single organization), may be public (e.g., available to many organizations), and/or a combination thereof (e.g., a hybrid cloud environment).

The client device(s) may include at least some of the components, features, and functionality of the example computing device(s) 1200 described herein with respect to FIG. 12. By way of example and not limitation, a client device may be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a remote control, an appliance, a consumer electronic device, a workstation, an edge device, any combination of these delineated devices, or any other suitable device.

The disclosure may be described in the general context of computer code or machine-useable instructions, including computer-executable instructions such as program modules, being executed by a computer or other machine, such as a personal data assistant or other hand-held device. Generally, program modules including routines, programs, objects, components, data structures, etc., refer to code that perform particular tasks or implement particular abstract data types. The disclosure may be practiced in a variety of system configurations, including hand-held devices, consumer electronics, general-purpose computers, more specialty computing devices, etc. The disclosure may also be practiced in distributed computing environments where tasks are performed by remote-processing devices that are linked through a communications network.

Other variations are within the spirit of present disclosure. Thus, while disclosed techniques are susceptible to various modifications and alternative constructions, certain illustrated embodiments thereof are shown in drawings and have been described above in detail. It should be understood, however, that there is no intention to limit disclosure to specific form or forms disclosed, but on contrary, intention is to cover all modifications, alternative constructions, and equivalents falling within spirit and scope of disclosure, as defined in appended claims.

Use of terms “a” and “an” and “the” and similar referents in context of describing disclosed embodiments (especially in context of following claims) are to be construed to cover both singular and plural, unless otherwise indicated herein or clearly contradicted by context, and not as a definition of a term. Terms “comprising,” “having,” “including,” and “containing” are to be construed as open-ended terms (meaning “including, but not limited to,”) unless otherwise noted. “Connected,” when unmodified and referring to physical connections, is to be construed as partly or wholly contained within, attached to, or joined together, even if there is something intervening. Recitation of ranges of values herein are merely intended to serve as a shorthand method of referring individually to each separate value falling within range, unless otherwise indicated herein and each separate value is incorporated into specification as if it were individually recited herein. In at least one embodiment, use of the term “set” (e.g., “a set of items”) or “subset” unless otherwise noted or contradicted by context, is to be construed as a nonempty collection comprising one or more members. Further, unless otherwise noted or contradicted by context, the term “subset” of a corresponding set does not necessarily denote a proper subset of the corresponding set, but subset and corresponding set may be equal.

Conjunctive language, such as phrases of form “at least one of A, B, and C,” or “at least one of A, B and C,” unless specifically stated otherwise or otherwise clearly contradicted by context, is otherwise understood with context as used in general to present that an item, term, etc., may be either A or B or C, or any nonempty subset of set of A and B and C. For instance, in illustrative example of a set having three members, conjunctive phrases “at least one of A, B, and C” and “at least one of A, B and C” refer to any of following sets: {A}, {B}, {C}, {A, B}, {A, C}, {B, C}, {A, B, C}. Thus, such conjunctive language is not generally intended to imply that certain embodiments require at least one of A, at least one of B and at least one of C each to be present. In addition, unless otherwise noted or contradicted by context, the term “plurality” indicates a state of being plural (e.g., “a plurality of items” indicates multiple items). In at least one embodiment, a number of items in a plurality is at least two, but can be more when so indicated either explicitly or by context. Further, unless stated otherwise or otherwise clear from context, the phrase “based on” means “based at least in part on” and not “based solely on.”

Operations of processes described herein can be performed in any suitable order unless otherwise indicated herein or otherwise clearly contradicted by context. In at least one embodiment, a process such as those processes described herein (or variations and/or combinations thereof) is performed under control of one or more computer systems configured with executable instructions and is implemented as code (e.g., executable instructions, one or more computer programs or one or more applications) executing collectively on one or more processors, by hardware or combinations thereof. In at least one embodiment, code is stored on a computer-readable storage medium, for example, in the form of a computer program comprising a plurality of instructions executable by one or more processors. In at least one embodiment, a computer-readable storage medium is a non-transitory computer-readable storage medium that excludes transitory signals (e.g., a propagating transient electric or electromagnetic transmission) but includes non-transitory data storage circuitry (e.g., buffers, cache, and queues) within transceivers of transitory signals. In at least one embodiment, code (e.g., executable code or source code) is stored on a set of one or more non-transitory computer-readable storage media having stored thereon executable instructions (or other memory to store executable instructions) that, when executed (i.e., as a result of being executed) by one or more processors of a computer system, cause computer system to perform operations described herein. In at least one embodiment, set of non-transitory computer-readable storage media comprises multiple non-transitory computer-readable storage media and one or more of individual non-transitory storage media of multiple non-transitory computer-readable storage media lack all of code while multiple non-transitory computer-readable storage media collectively store all of code. In at least one embodiment, executable instructions are executed such that different instructions are executed by different processors—for example, a non-transitory computer-readable storage medium store instructions and a main central processing unit (“CPU”) executes some of instructions while a graphics processing unit (“GPU”) executes other instructions. In at least one embodiment, different components of a computer system have separate processors and different processors execute different subsets of instructions.

Accordingly, in at least one embodiment, computer systems are configured to implement one or more services that singly or collectively perform operations of processes described herein and such computer systems are configured with applicable hardware and/or software that enable performance of operations. Further, a computer system that implements at least one embodiment of present disclosure is a single device and, in another embodiment, is a distributed computer system comprising multiple devices that operate differently such that distributed computer system performs operations described herein and such that a single device does not perform all operations.

Use of any and all examples, or exemplary language (e.g., “such as”) provided herein, is intended merely to better illuminate embodiments of disclosure and does not pose a limitation on scope of disclosure unless otherwise claimed. No language in specification should be construed as indicating any non-claimed element as essential to practice of disclosure.

All references, including publications, patent applications, and patents, cited herein are hereby incorporated by reference to the same extent as if each reference were individually and specifically indicated to be incorporated by reference and were set forth in its entirety herein.

In description and claims, terms “coupled” and “connected,” along with their derivatives, may be used. It should be understood that these terms may be not intended as synonyms for each other. Rather, in particular examples, “connected” or “coupled” may be used to indicate that two or more elements are in direct or indirect physical or electrical contact with each other. “Coupled” may also mean that two or more elements are not in direct contact with each other, but yet still co-operate or interact with each other.

Unless specifically stated otherwise, it may be appreciated that throughout specification terms such as “processing,” “computing,” “calculating,” “determining,” or like, refer to action and/or processes of a computer or computing system, or similar electronic computing device, that manipulate and/or transform data represented as physical, such as electronic, quantities within computing system's registers and/or memories into other data similarly represented as physical quantities within computing system's memories, registers or other such information storage, transmission or display devices.

In a similar manner, the term “processor” may refer to any device or portion of a device that processes electronic data from registers and/or memory and transforms that electronic data into other electronic data that may be stored in registers and/or memory. As non-limiting examples, “processor” may be a CPU or a GPU. A “computing platform” may comprise one or more processors. As used herein, “software” processes may include, for example, software and/or hardware entities that perform work over time, such as tasks, threads, and intelligent agents. Also, each process may refer to multiple processes, for carrying out instructions in sequence or in parallel, continuously or intermittently. In at least one embodiment, terms “system” and “method” are used herein interchangeably insofar as a system may embody one or more methods and methods may be considered a system.

In the present document, references may be made to obtaining, acquiring, receiving, or inputting analog or digital data into a subsystem, computer system, or computer-implemented machine. In at least one embodiment, a process of obtaining, acquiring, receiving, or inputting analog and digital data can be accomplished in a variety of ways such as by receiving data as a parameter of a function call or a call to an application programming interface. In at least one embodiment, processes of obtaining, acquiring, receiving, or inputting analog or digital data can be accomplished by transferring data via a serial or parallel interface. In at least one embodiment, processes of obtaining, acquiring, receiving, or inputting analog or digital data can be accomplished by transferring data via a computer network from providing entity to acquiring entity. In at least one embodiment, references may also be made to providing, outputting, transmitting, sending, or presenting analog or digital data. In various examples, processes of providing, outputting, transmitting, sending, or presenting analog or digital data can be accomplished by transferring data as an input or output parameter of a function call, a parameter of an application programming interface or interprocess communication mechanism.

Although descriptions herein set forth example embodiments of described techniques, other architectures may be used to implement described functionality, and are intended to be within scope of this disclosure. Furthermore, although specific distributions of responsibilities may be defined above for purposes of description, various functions and responsibilities might be distributed and divided in different ways, depending on circumstances.

Furthermore, although subject matter has been described in language specific to structural features and/or methodological acts, it is to be understood that subject matter claimed in appended claims is not necessarily limited to specific features or acts described. Rather, specific features and acts are disclosed as exemplary forms of implementing the claims.

What is claimed is:

1. A method comprising:
processing, using an encoder, one or more audio frames representative of a speech to generate one or more embeddings encoding the speech; and
processing, using a plurality of decoders, the one or more embeddings to generate a plurality of transcriptions of the speech, an individual transcription of the plurality of transcriptions (i) being generated by a respective decoder of the plurality of decoders and (ii) conforming to a respective text format of a plurality of text formats that differs from other text formats of the plurality of text formats in at least one of capitalization, punctuation, use of non-alphabet characters, or identification of individual utterances of the speech.

2. The method of claim 1, wherein the plurality of decoders comprises one or more of:
a connectionist temporal classification (CTC) decoder, or
a transducer decoder,
a hybrid CTC-transducer decoder, or
a token-and-duration transducer decoder.

3. The method of claim 1, wherein the plurality of text formats comprises a normalized text format associated with representing text content with single-case alphabet characters.

4. The method of claim 1, wherein the plurality of text formats comprises an inverse normalized text format associated with representing numbers with numeral characters.

5. The method of claim 4, wherein the inverse normalized text format is further associated with representing at least some of vocabulary words with non-alphanumerical characters.

6. The method of claim 1, wherein the plurality of text formats comprises one or more text formats that comprise a combination of at least two other text formats of the plurality of text formats.

7. The method of claim 1, wherein the identification of individual utterances of the speech comprises identification of at least one content unit of the speech, the content unit comprising multiple sentences of the speech having at least one of a common meaning, logic, semantics, or context.

8. The method of claim 1, wherein the plurality of decoders are trained using an aggregated loss value computed based at least on at least a plurality of loss values, an individual loss value of the plurality of loss values being associated with an accuracy of a training text output generated, by a corresponding decoder of the plurality of decoders, for a training speech input.

9. A method comprising:
processing, using an encoder, one or more audio frames representative of a training speech to generate one or more embeddings encoding the training speech;
processing, using a plurality of decoders, the one or more embeddings to generate a plurality of transcriptions of the training speech, wherein an individual transcription of the plurality of transcriptions (i) is generated by a respective decoder of the plurality of decoders and (ii) conforms to a respective text format of a plurality of text formats that differs from other text formats of the plurality of text formats in at least one of capitalization, punctuation, use of non-alphabet characters, or identification of individual utterances of the training speech; and
training one or more decoders of the plurality of decoders based at least on at least the plurality of transcriptions of the training speech.

10. The method of claim 9, wherein the training the one or more decoders comprises:
computing a plurality of loss values, an individual loss value of the plurality of loss values characterizing accuracy of a corresponding transcription of the plurality of transcriptions of the training speech;
computing, based at least on at least the plurality of loss values, an aggregated loss value; and
modifying, using the aggregated loss value, parameters of the one or more decoders.

11. The method of claim 10, wherein at least two loss values of the plurality of loss values are weighted with unequal weights in the aggregated loss value.

12. The method of claim 10, wherein the plurality of loss values are computed based at least on a plurality of ground truth transcriptions generated by processing the training speech using a cascade automatic speech recognition (ASR) system that comprises:
an ASR model configured to process the training speech to generate a first ground truth transcription of the plurality of ground truth transcriptions; and
a text processing model configured to process the first ground truth transcription to generate a second ground truth transcription of the plurality of ground truth transcriptions.

13. The method of claim 12, wherein the first ground truth transcription conforms to a normalized text format associated with representing text content with single-case alphabet characters, and wherein the second ground truth transcription conforms to text format representing at least one of:
a capitalized text format,
a punctuated text format,
a text format with non-alphabet characters, or
a text format that identifies utterances of the first ground truth transcription.

14. The method of claim 9, wherein the plurality of text formats comprises an inverse normalized text format associated with representing numbers with numeral characters.

15. The method of claim 9, further comprising:
training, using the plurality of transcriptions of the training speech, the encoder.

16. A system comprising:
one or more processors to:
process, using an encoder, audio data to generate one or more embeddings encoding speech represented in the audio data;
process, using a plurality of decoders, the one or more embeddings to generate a plurality of transcriptions of the speech, wherein an individual transcription of the plurality of transcriptions (i) is generated by a respective decoder of the plurality of decoders and (ii) conforms to a respective text format of a plurality of text formats that differs from other text formats of the plurality of text formats; and
train one or more decoders of the plurality of decoders based on at least the plurality of transcriptions of the speech.

17. The system of claim 16, wherein to train the one or more decoders the one or more processors are to:
compute a plurality of loss values, an individual loss value of the plurality of loss values characterizing accuracy of a corresponding transcription of the plurality of transcriptions of the speech;
compute, based at least on at least the plurality of loss values, an aggregated loss value; and
modify, using the aggregated loss value, parameters of the one or more decoders.

18. The system of claim 17, wherein at least two loss values of the plurality of loss values are weighted with unequal weights in the aggregated loss value.

19. The system of claim 17, wherein the plurality of loss values are computed based at least on a plurality of ground truth transcriptions generated by processing the speech using a cascade automatic speech recognition (ASR) system that comprises:
an ASR model configured to process the speech to generate a first ground truth transcription of the plurality of ground truth transcriptions; and
a text processing model configured to process the first ground truth transcription to generate a second ground truth transcription of the plurality of ground truth transcriptions.

20. The system of claim 16, wherein the system is comprised in at least one of:
an in-vehicle infotainment system for an autonomous or semi-autonomous machine;
a system for performing simulation operations;
a system for performing digital twin operations;
a system for performing light transport simulation;
a system for performing one or more medical operations;
a system for performing one or more factory operations;
a system for performing one or more analytics operations;
a system implementing one or more inference microservices;
a system for performing light transport simulations;
a system for performing collaborative content creation for 3D assets;
a system for performing deep learning operations;
a system implemented using an edge device;
a system for generating or presenting at least one of virtual reality content, mixed reality content, or augmented reality content;
a system implemented using a robot;
a system for performing one or more conversational AI operations;
a system implementing one or more large language models (LLMs);
a system implementing one or more vision language models (VLMs);
a system implementing one or more multi-modal language models (MMLMs);
a system implementing one or more language models;
a system for performing one or more generative AI operations;
a system for generating synthetic data;
a system incorporating one or more virtual machines (VMs);
a system implemented at least partially in a data center; or
a system implemented at least partially using cloud computing resources.
